(19) United States
(12) Patent Application Publication
(10) Pub. No.: US 2023/0153610 A1
(43) Pub. Date: May 18, 2023

(54) USING MACHINE TRAINED NETWORKS TO ANALYZE GOLF SWINGS

(71) Applicant: eGolf.ai, Inc., Saratoga, CA (US)

(72) Inventors: Emi Siao Fujimura, Saratoga, CA (US); Tadashi Siao Fujimura, Saratoga, CA (US); Aki Fujimura, Saratoga, CA (US); Tanish Baranwal, Saratoga, CA (US)

(21) Appl. No.: 17/989,655

(22) Filed: Nov. 17, 2022

Related U.S. Application Data
(60) Provisional application No. 63/399,531, filed on Aug. 19, 2022.
(60) Provisional application No. 63/280,282, filed on Nov. 17, 2021.

(51) Int. Cl. G06N 3/08

(52) U.S. Cl. CPC G06N 3/08

(57) ABSTRACT

Some embodiments provide a method of training a neural network to identify a type of golf swing based on a sound produced by an impact between a clubhead of a golf club and a golf ball. The method provides the neural network with multiple sets of inputs associated with multiple swings and multiple corresponding sets of known outputs. Each set of inputs includes at least (1) a spectrogram associated with sounds produced by the swing, and (2) impact position derived from impact tape on the clubhead used during the swing. The method uses the neural network to process each set of inputs to produce multiple sets of generated outputs. The method compares the known outputs with the generated outputs to compute error values that express differences between the known and generated outputs. The method propagates inputs associated with the computed error values back through the neural network and adjusts one or more adjustable parameters based on the computed error values.

### BACKGROUND

Today, golf coaches are able to decipher the kind of hit resulting from a golf swing based solely on hearing the sound of the club striking the ball, even despite the various types of clubs and various types of golf balls used. While there are products (e.g., mobile phone applications) available for analyzing swings, such products tend to focus on what physically occurred, such as by outputting metrics like swing speed, swing path, ball speed, launch angle, “smash factor”, etc. However, apart from some analyzers that offer to send pictures of the swing to a professional coach for an added fee, these products do not have built-in capabilities to provide advice in response to their analyses (e.g., whether the swing was good or bad, what could be done to improve the swing, etc.).

### BRIEF SUMMARY

Some embodiments of the invention provide a method of training a neural network to identify a type of golf swing based on a sound produced by an impact between a clubhead of a golf club and a target ball object (e.g., a golf ball). The neural network includes multiple processing nodes that each have adjustable parameters. The method provides the neural network with multiple training sets associated with multiple golf swings and impacts between the clubhead and the target ball object during the golf swings.

Each training set, in some embodiments, includes multiple known input/output pairs, with each known input/output pair including (1) at least sound clip (e.g., an audio file or stream of audio) produced by the swing and during the impact as the known input, and (2) an impact position derived from impact tape on the clubhead used during the swing as the known output. The method then uses the neural network to process each training set to produce multiple sets of generated outputs.

The method then uses the generated outputs and the known outputs to compute a loss function (e.g., uses the difference between the generated and known outputs for a training set to compute the loss function). The method then performs a back propagation operation based on the computed loss function to adjust the trainable parameters of the neural network (e.g., back propagates the computed loss function value through the neural network based on gradients to adjust the configurable weight values of the neural network).

In some embodiments, each adjustable parameter is a weight value that indicates the importance of a feature (e.g., a known input) and the relationship between the feature (e.g., the known input) and a target output. Adjusting these weight values can include increasing weight values associated with, for instance, an aspect of the sound of the impact between the clubhead and golf ball (e.g., amplitude of the sound, frequency of the sound, etc.), and the impact position on the clubhead (e.g., according to the impact tape). Increasing these weight values, in some embodiments, is useful for training the neural network to subsequently be able to infer impact position based solely on the sound graph and without the use of the impact tape (i.e., based on the strong correlation between the impact sound and impact position).

In addition to sound and impact position, the training sets, in some embodiments, also include metrics such as swing speed (i.e., speed of the clubhead at the time of impact), swing path (i.e., path of the clubhead during the swing), ball speed (i.e., speed of the golf ball once it has been struck), launch angle (i.e., the angle of the golf ball once it has been struck), ball spin direction (i.e., the direction the golf ball spins once it has been struck), and ball spin rate (i.e., how fast the golf ball spins over time once it has been struck). In some embodiments, other metrics, such as “smash factor” and data collected from a pressure pad upon which the golfer taking the swing stands, are collected and included in the training sets used to train the neural network. In some embodiments, the metrics are produced by other neural networks and/or other assessment programs that infer the metrics using the impact position produced by the neural network. Also, in some embodiments, the impact sound(s) and/or non-impact sound(s) are also provided with the outputted impact position to the other neural networks and/or assessment programs for use in inferring the metrics.

In some embodiments, videos from a single angle, or multiple angles, of a golfer, a club, and a ball are captured and processed by other neural networks to collect other data, which is, in turn, included in the training sets used to train the neural network. Examples of such other data in some embodiments include swing path, swing tempo, relative positions of body parts of the golfer, the clubhead, and the ball. Other sources of training data, in some embodiments, can include various ball tracking devices, such as TrackMan, and high-speed cameras that capture the moment of impact, such as Full Swing ion3. The neural network of some embodiments is also trained to infer these metric values from sound (e.g., an audio file or stream of audio) as input in addition to inferring impact position.

The generated outputs, in some embodiments, can include a rating of the associated swing, such as an indication of whether the swing was a “good” swing or a “bad” swing, as well as one or more suggestions for improving the swing. Such suggestions, in some embodiments, include suggestions on how the golfer can reposition themselves to deliver a better swing (e.g., move one inch closer to the golf ball), as well as suggestions on how to improve the swing itself (e.g., get the “swoosh” in front of you). After the neural network has been sufficiently trained (e.g., once the generated outputs consistently match the known outputs or fall within an acceptable range of the known outputs), it is implemented as part of a swing analyzer that can be used on, e.g., a mobile device by everyday users (e.g., by golfers on a golf range) or a smart watch by players on the course (e.g., in a “practice mode” to avoid rules violations during regulation play), and only requires sounds associated with the swing (e.g., by way of audio and/or video of the swing) as input.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1-3 illustrates three different golf swing analyzers of some embodiments.

FIG. 4 illustrates a swing analyzer that includes a neural network for processing various inputs associated with golf swings, in some embodiments.

FIG. 5 illustrates a first example of a spectrogram that provides a visualization of the sound of a golf club striking a golf ball and a corresponding depiction of the impact tape on a golf club face reflecting where the golf ball came into contact with the club's face during impact.

FIG. 6 illustrates a second example of a spectrogram that provides a visualization of the sound of a golf club striking a golf ball and a corresponding depiction of the impact tape on a golf club face reflecting where the golf ball came into contact with the club's face during impact.

FIG. 7 illustrates a process performed to train the neural network, in some embodiments.

FIG. 8 illustrates a process performed to use the swing analyzer of FIG. 4 to analyze a golf swing, in some embodiments.

FIG. 9 illustrates an example of a spectrogram, a diagram showing the point of impact on a clubhead, and a set of outputs, in some embodiments.

FIG. 10 illustrates an example of a graph in which impact position is inferred, in some embodiments.

FIG. 11 conceptually illustrates a process of some embodiments for training the neural network to infer various metric data based on impact and non-impact sound data associated with golf swings.

FIG. 12 conceptually illustrates an example of a spectrogram and corresponding sets of known and generated output results, in some embodiments.

FIG. 13 conceptually illustrates a process of some embodiments for processing impact and non-impact sound parameters to extract feedback parameters.

FIG. 14 illustrates an example of a spectrogram that is produced in some embodiments from sounds recording during a golf swing and impact between the golf club and golf ball.

FIG. 15 illustrates the spectrogram of FIG. 14 divided into different input sets, and identified as either “impact sounds” or “non-impact sounds”.

FIG. 16 conceptually illustrates a process of some embodiments for training a neural network to infer data associated with golf swings based on non-impact sounds during the golf swings.

FIGS. 17-18 conceptually illustrate examples of a swing arc and associated spectrogram, of some embodiments.

FIG. 19 conceptually illustrates a process of some embodiments for providing feedback based on the amount of statistical variation between different golf swings in a set of golf swings.

FIG. 20 conceptually illustrates an example of a set of output metrics of some embodiments and a set of categories defining thresholds for a subset of metrics to use to determine the feedback second set of outputs of some embodiments.

FIG. 21 conceptually illustrates a process of some embodiments for categorizing a golfer based on a quality level determined for a set of golf swings associated with the golfer.

FIG. 22 conceptually illustrates an example of a set of outputs and a set of categories defined according to at least one of the outputs.

FIG. 23 conceptually illustrates a diagram of a system of some embodiments for analyzing and processing swing-related input at a centralized location that includes a cloud-based analytics engine.

FIG. 24 conceptually illustrates a process of some embodiments for providing outputs based on sound parameters that are processed locally in a golf swing analyzer mobile application operating on a user device and video parameters that are processed externally at a cloud-based analytics engine.

FIGS. 25A-25C conceptually illustrate diagrams of a workflow of some embodiments between the swing analyzer application and the cloud-based analytics engine.

FIG. 26 illustrates a diagram of a golf swing that is separated into three categories, according to some embodiments.

FIG. 27 illustrates a spectrogram generated from sounds during the swing illustrated in FIG. 26.

FIG. 28 conceptually illustrates a neural network of some embodiments that includes multiple processing nodes for processing different sets of input fed to the neural network.

FIG. 29 conceptually illustrates a process of some embodiments for training a customized neural network for analyzing golf swings on a per-golfer basis.

FIG. 30 conceptually illustrates an example of a cloud-based analytics engine of some embodiments that includes a generic neural network and multiple custom neural networks.

FIG. 31 illustrates a display provided by the swing analyzer application of some embodiments.

FIG. 32 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method of training a neural network to identify various characteristics of an impact between a clubhead of a golf club and a target ball object (e.g., a golf ball) made with the ball and the consequences of that on the target ball object's trajectory based on a sound produced by an impact between a clubhead of the golf club and the target ball object. The neural network includes multiple processing nodes that each have adjustable parameters.

The method provides the neural network with multiple training sets associated with multiple golf swings and impacts between the clubhead and the target ball object during the golf swings. Each training set, in some embodiments, includes multiple known input/output pairs, with each known input/output pair including (1) at least sound clip (e.g., an audio file or stream of audio) produced by the swing and during the impact as the known input, and (2) an impact position derived from impact tape on the clubhead used during the swing as the known output.

The method then uses the generated outputs and the known outputs to compute a loss function (e.g., uses the difference between the generated and known outputs for a training set to compute the loss function). The method then performs a back propagation operation based on the computed loss function to adjust the trainable parameters of the neural network (e.g., back propagates the computed loss function value through the neural network based on gradients to adjust the configurable weight values of the neural network).

In some embodiments, each adjustable parameter is a weight value that indicates the importance of a feature (e.g., a known input) and the relationship between the feature (e.g., the known input) and a target output. Adjusting these weight values can include increasing weight values associated with, for instance, an aspect of the sound of the impact between the clubhead and golf ball (e.g., amplitude of the sound, frequency of the sound, etc.), and the impact position on the clubhead (e.g., according to the impact tape). Increasing these weight values, in some embodiments, is useful for training the neural network to subsequently be able to infer impact position based solely on the sound graph and without the use of the impact tape (i.e., based on the strong correlation between the impact sound and impact position).

It should be noted that in the embodiments described herein, the phrase “time of impact” is generally used to indicate the time of and around impact (i.e., impact between a clubhead and golf ball). At the time of impact, in a fraction of a second, but still over a certain duration of time, the clubhead contacts the ball and compresses the ball, causing the ball to bounce off the clubhead, and applying force to the golf ball in a target direction and loft. Consistent application of the force in the same direction throughout that duration of time is generally better for the ensuing golf shot. An important element of the present invention is that the sound generated by the impact captures this duration in addition to the impact position.

In addition to sound and impact position, as well as the force applied during the duration of the impact, the training sets, in some embodiments, also include metrics such as swing speed (i.e., speed of the clubhead during the swing), swing path (i.e., path of the clubhead during the swing), ball speed (i.e., speed of the golf ball once it has been struck), launch angle (i.e., the angle of the golf ball once it has been struck), ball spin direction (i.e., the direction the golf ball spins once it has been struck), and ball spin rate (i.e., how fast the golf ball spins over time once it has been struck). In some embodiments, other metrics, such as “smash factor” and data from other devices, such as a pressure pad upon which the golfer taking the swing stands, a video recording device that captures very high-speed videos of the duration of the impact, are collected and included in the training sets used to train the neural network. In some embodiments, the metrics are produced by other neural networks and/or other assessment programs that infer the metrics using the impact position produced by the neural network. Also, in some embodiments, the impact sound(s) and/or non-impact sound(s) are also provided with the outputted impact position to the other neural networks and/or assessment programs for use in inferring the metrics.

In some embodiments, the collected data can be collected for neural network training from swing simulators and analyzers so that the network can be used subsequently to infer information such as distance the ball should have traveled, the curvature of the ball, the height of the ball, and other information based solely on the sound(s) and without the use of an independent swing analysis or simulator. The present invention also contemplates the use of the information gathered by this method to augment swing analysis or golf simulation software, for example, for enhanced accuracy. Furthermore, the present invention also contemplates the use of the information gathered by this method to assist golfers during (practice) rounds in finding the ball from smart phones or smart watches based on sound alone, or sound augmented with other information from various sensors and/or recording devices.

The generated outputs, in some embodiments, can include a rating of the associated swing, such as an indication of whether the swing was a “good” swing or a “bad” swing, as well as one or more suggestions for improving the swing. Such suggestions, in some embodiments, include suggestions on how the golfer can reposition themselves to deliver a better swing (e.g., move one inch closer to the golf ball), as well as suggestions on how to improve the swing itself (e.g., get the “swoosh” in front of you).

In some embodiments, video is also included in the training sets for training the neural network, or another different neural network. The video can be taken from behind (i.e., looking down the intended target line), from the front (i.e., looking straight at the person taking the swing), from the top of the golfer, or from behind the golfer, or from multiple angles at the same time to form a “360” view, or in any combination, according to some embodiments. Regardless of the view, some embodiments have a lot of tolerance for angle differences. The neural network or another neural network, in some embodiments, is built and configured to learn to recognize a hand, a clubhead, shaft, elbows, shoulders, hips, knees, and feet including feet angle and the ball or any subset thereof in every frame of the video. The video is then turned into a swing arc over a period of time, in some embodiments, including the timings of each frame in the arc. In some embodiments, some of the metrics included in the training sets as known outputs described above, such as swing speed, swing path, ball speed, launch angle, “smash factor”, ball spin direction, ball spin rate, etc., are extrapolated from the video in addition to the sound.

The videos, in some embodiments, are used to train a separate neural network for motion detection such that video provided as input is translated into a series of stick diagrams depicting stages of movements of the golfer, the club, and the ball during swings captured by the videos. In some such embodiments, the series of stick diagrams are then translated into a movement arc of the golfer, club, and ball, or, more specifically, in some embodiments, a movement arc of the clubhead and the golfer's hands. The movement arc, in some embodiments, includes timing information to capture tempo of the captured swings. In some embodiments, the resulting output of this analysis by this separately trained neural network is then combined with sound and information from other sensors (e.g., sensors in a smart watch worn by the golfer) to provide the most informed analysis of the captured swings associated with the input, and, in some embodiments, suggestions for improvement.

As a point of emphasis, suggestions for improvement, in some embodiments, are determined based on the video input and, in some embodiments, information collected by sensors (e.g., sensors in a smart watch worn by the golfer during the capture swings). For instance, determinations regarding what a particular golfer needs to improve on (i.e., what the golfer did wrong) are best determined using the video, which allows for more information to be extrapolated compared to, e.g., sound as input alone. Determinations regarding how well the ball did (i.e., how good the results of the swing are on the ball in terms of distance, direction, speed, etc.), regardless of the quality of the swing, however, can be determined through sound alone, according to some embodiments.

In some embodiments, the additional sensors used to collect input data include sensors in a smart watch worn by the golfer, as mentioned above. The sensors in the smart watch, in some embodiments, include sensors that can detect when the watch is face down relative to gravity, as well as sensors that can detect changes in momentum. The combination of these sensors, in some embodiments, can provide a good approximation of a golfer's wrist's swing path, and a direction in which the golfer's forearm was pointed throughout each swing.

The neural network, in some embodiments, is trained in a controlled environment, and later implemented on mobile devices once training has been completed. In some embodiments, the training includes providing the neural network with as many training sets as possible in order to ensure the neural network is able to produce ample and accurate generated outputs when provided with more limited sets of inputs. For example, the impact tape and pressure pads that are used in some embodiments to train the neural network are not required to use the swing analyzer in the field (e.g., via a mobile device or a smart watch operated by a user on a driving range). In some embodiments, a swing simulator is used to gather metrics data to include in the training sets used to train the neural network, such as swing path, swing speed, ball speed, spin rate. etc. These metrics enable the neural network to predict the ball's flight path, according to some embodiments.

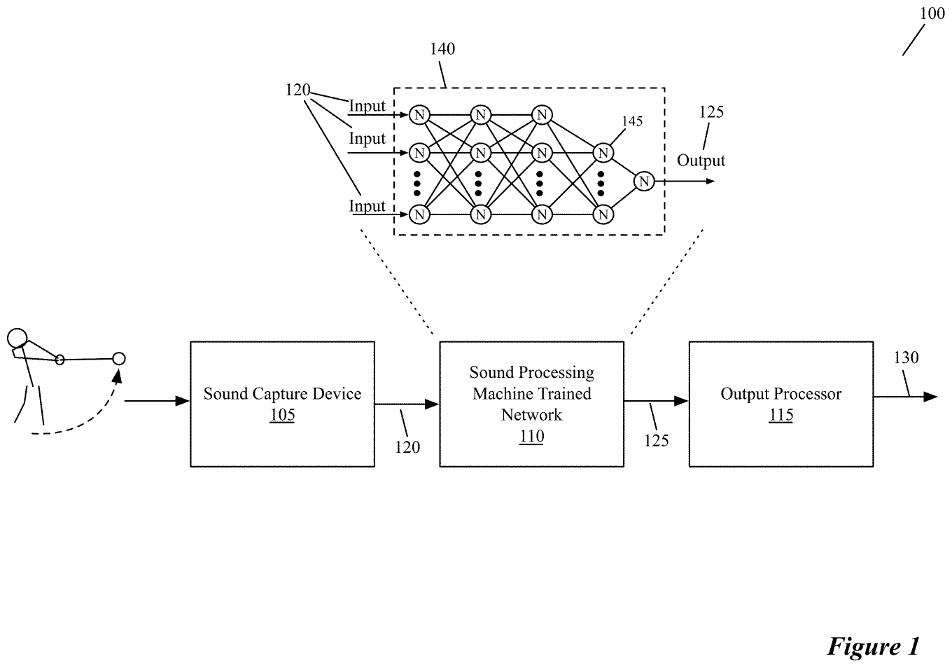

FIG. 1 illustrates a golf swing analyzer 100 of some embodiments. As shown, this golf swing analyzer 100 includes a sound capture device 105, a sound processing machine trained network 110, and an output processor 115. In some embodiments, these components are all implemented by a mobile device (e.g., a smart phone or tablet) or a local computing device (e.g., a laptop or desktop computer) at the location where the user is taking the swings. As further described below, one or more of these components in other embodiments are located at remote locations from the user's location (e.g., are server-side components).

The sound capture device 105 captures the sound associated with a golf swing. This sound includes the impact sound between a clubhead of a golf club used for the swing and a target ball object (e.g., a golf ball). In some embodiments, the sound also includes the sounds of the golf club moving through space before and after the impact between the clubhead and target ball object (e.g., golf swing sounds). In some embodiments, the golf swing sounds also include the “swoosh” sound that occurs around the time of the impact.

As mentioned above, the sound capture device 105, in some embodiments, belongs to a local mobile device or computing device. For instance, the sound capture device is the microphone and audio processing modules of a mobile device (e.g., a smart phone, a tablet, or a smart watch) or local computer device (e.g., a laptop computer) at the location of the user.

The sound-processing machine trained network 110 produces impact location on the clubhead. That is, the sound-processing machine trained network 110 receives the sound 120 from the sound capture device 105 and processes the sound to produce impact location on the clubhead. The sound-processing machine trained network 110 includes a neural network that has configurable parameters (e.g., weights) that have been trained through a learning process that used large number of training sets that include multiple input/output tuples. In some embodiments, the input/output tuples of the training sets include known input sound data for a golf swing and known output data that is the location on a golf clubhead for the impact (e.g., as captured by an impact tape or other mechanisms as further described below). The neural network 140 receives input(s) 120, which is processed by the neurons 145 to produce the output(s) 125.

The golf swing analyzer 100 shows a pictorial representation of a neural network 140 as an example of the machine trained network 110. As shown, the neural network 140 includes multiple trained neurons 145 that have configurable weight parameters that have been adjusted during multiple iterations (e.g., hundreds, thousands, etc.) of processing training sets used to train the neural network 140.

The output processor 115 provides golf swing assessments. After the sound-processing machine trained network 110 processes the sound 120 it receives from the sound capture device 105, the sound-processing machine trained network 110 provides the generated impact location 125 to the output processor 115. The output processor 115 uses the generated impact location 125 to provide verbal (immediate audible response) and/or visual (e.g., displayed on a display screen, or stored in a storage for later display on a display screen or later audible playback with or without playback of a video of the associated golf swing) output(s) 130. The output processor 115 of some embodiments is the speaker and audio processing unit of the local mobile device (e.g., smart phone, tablet, smart watch) or local computing device (e.g., laptop) of the user.

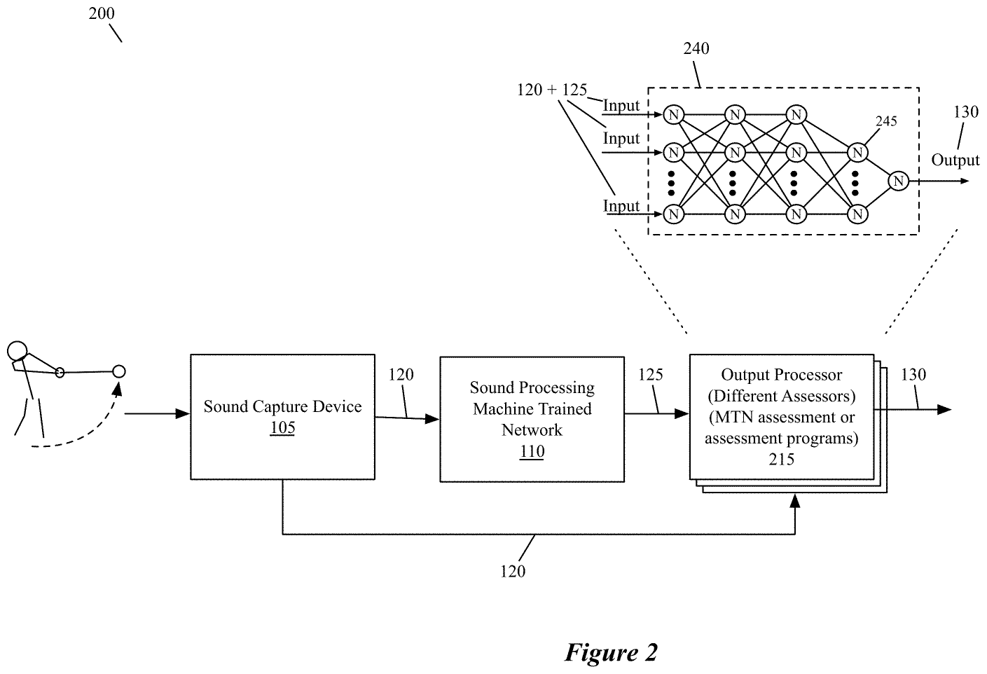

The golf swing analyzer of some embodiments has multiple output processors that serve as multiple different golf swing assessors (i.e., perform multiple different golf swing assessment operations), such as the golf swing analyzer 200 illustrated in FIG. 2. The golf swing analyzer 200 includes the sound capture device 105, the sound-processing machine trained network 110, and multiple output processors 215.

Examples of the myriad of different assessments provided by the multiple output processors 215, in some embodiments, include metric data and feedback data. The metric data of some embodiments includes distance, ball speed, club speed, launch angle, launch spin, carry, ball spin rate, swing path, swing speed, ball spin direction, and smash factor. The feedback data includes analysis feedback, such as indications of the quality of the golf swing(s) (e.g., what the user did or did not do well), and/or advice feedback, such as suggestions for improving future golf swings (e.g., “remember to drag the club straight back on take away”).

Some of the assessors in the multiple output processors 215 receive and use the impact location output 125 from the sound-processing machine trained network 110 to produce outputs 130, while other assessors in the multiple output processors 215 receive and use the impact location output 125 from the sound-processing machine trained network 110 plus the captured sound file 120, which can include golf swing sounds and/or impact sounds. Still other assessors in the multiple output processors 215 receive and use the impact location output 125, the captured sound files 120, and/or output(s) of other assessors in the output processors 215. The output processors 215 use the inputs that they receive to generate their assessments for each golf swing.

Each of the output processors 215 is a respective neural network or an analytical assessment program (e.g., algorithmic function). For instance, one or more of these output processors 215 includes a neural network 240. Like the neural network 140 described above, the neural network 240 also includes multiple trained neurons 245 that have configurable weight parameters that have been adjusted during multiple iterations (e.g., hundreds, thousands, etc.) of processing training sets used to train the neural network 240. In this example, the neural network 240 receives input 120 and 125 for processing by the neurons 245 to produce the output(s) 130.

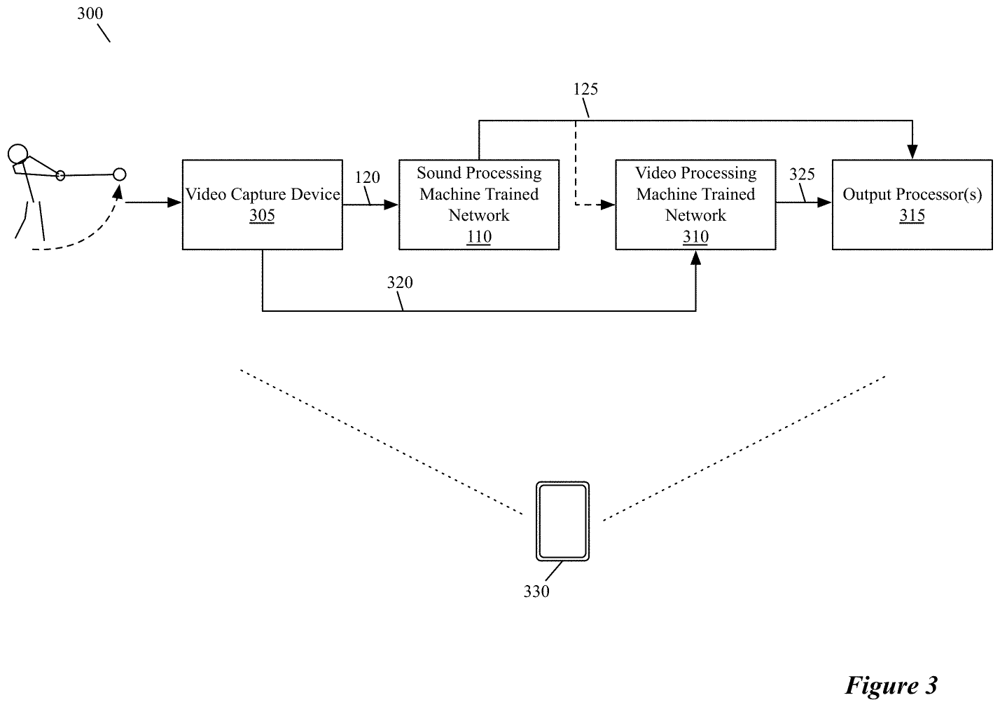

FIG. 3 illustrates another example of a golf swing analyzer 300 of some embodiments. This golf swing analyzer 300 not only has multiple output processors 315, but also uses captured video data along with captured audio data from one or more golf swings to provide feedback. As shown, the golf swing analyzer 300 includes a video capture device 305, the sound-processing machine trained network 110, a video-processing machine trained network 310, and output processor(s) 315.

The golf swing analyzer 300 also shows an embodiment where all of the components 305, 110, 310, and 315 are implemented as being part of a mobile phone 330. However, in other embodiments, these components 305, 110, 310, and 315 are implemented by a local tablet or local computing device (laptop, desktop). Moreover, as further described below, some embodiments implement the video processing components by remote servers that have more compute power to perform deep learning operations, while using local audio processing components (e.g., of local smartphones, tablets, computing devices, etc.) to perform the less computationally intensive audio processing operations.

As shown, the golf swing analyzer 300 has a sound-processing machine trained network 110 and a video-processing machine trained network 310. The capture device of the golf swing analyzer 300 is a video capture device 305 of the local device (e.g., the smartphone 330 in this example, which can be replaced by the video capture device of any other local device, such as a tablet, a laptop, or other computing device). Sound data 120 (e.g., the sound file(s) or track(s)) from the captured video for each golf club swing (golf swing sounds and impact sounds) go to the sound-processing machine trained network 110, while the video data 320 (e.g., the video file or track) from the captured video is supplied to the video-processing machine trained network 310.

The sound-processing machine trained network 110 produces from the supplied sound file 120 the impact location 125 of each impact sound of each golf swing. In some embodiments, the video-processing machine trained network 310 also receives the output 125 of the sound-processing machine trained network 110 for each golf swing, and in order to identify a precise moment of impact (since a video does not capture the exact moment of impact because not enough samples are taken compared to the speed of the swing), the time stamps are used to more precisely interpolate the positions of the body parts, the club head and the shaft so that the analysis of the impact position is more precise. In some embodiments, the sound data 120 is also separately supplied to the video-processing machine trained network 310.

The video-processing machine trained network 310 includes a trained neural network (not shown) for processing the video data 320 (as well as any other data 120 and/or 125). To process the video data, each portion in the video that is associated with a golf swing is fed to the video-processing machine trained network 310 as input to produce the video-processing machine trained network 310 output data 325 that can be used to assess the golf swing as the output of the video-processing machine trained network 310.

Both the sound-processing machine trained network 110 outputs 125 and the video-processing machine trained network 310 outputs 325 go through one or more output processors 315 in order to provide multiple assessments regarding the golf swing. In some embodiments, these assessments range from immediate feedback based on the sound analysis and assessment, and slower feedback based on the video analysis and assessment. The video analysis is done locally, in some embodiments, and remotely on servers in other embodiments. The immediate sound-based assessments, in some embodiments, are audible (e.g., using the speakers of the user's device). Also, in some embodiments, the output is provided as video (e.g., a video example for how to improve the swing) through a display screen.

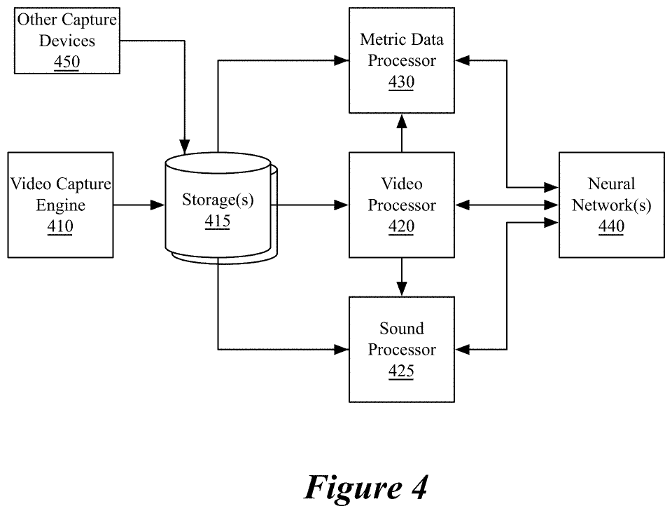

To produce the sound and/or video data for the machine-trained networks to analyze, some embodiments use one or more data extractors to extract sound and/or video clips from captured sound and/or video files and provide these clips to the machine-trained networks. FIG. 4 illustrates three data extractors that are used by a golf swing analyzer 400 of some embodiments. These three extractors are a video processor 420, a sound processor 425, and a metric data processor 430 of the swing analyzer 400, which feed sound, video and metric data associated with golf swings to one or more machine trained networks 440 of the swing analyzer. In FIG. 4, the machine-trained networks 440 are neural networks.

As shown, a video capture engine 410 of the swing analyzer 400 captures a video of a golfer taking multiple swings during a particular training session, and stores the captured video in a set of one or more storages 415. Along with this video, the swing analyzer 400 of some embodiments captures other metrics by using metric capture devices 450, and stores these other metrics in the storage set 415, as further described below.

As mentioned above, each of the processors 420-430 in some embodiments is a data extraction engine for extracting relevant data from inputs stored in the storages 415 to provide to the neural networks 440. For instance, in some embodiments, the video capture engine 410 produces a video of a golfer during a training session and continuously stores the video in the storage 415. The video processor 420 in some embodiments continuously retrieves the stored video, identifies portions of the video that correspond to golf swings, and produces data (e.g., time stamp data that could be used to identify one or more video frames or associated audio data associated with such video frames) that identifies the different portions of the video that are associated with the different golf swings.

In some embodiments, the video processor 420 provides the produced data (e.g., the time stamp data) for each golf swing to the sound processor 425. The sound processor then uses the produced data to extract audio clips of the identified portions (of the video that correspond to golf swings), and provides the extracted audio clips to a sound-processing neural network 440 to process. In other embodiments, the video processor 420 extracts the audio data from the identified video portions corresponding to the golf swings and provides this audio data to a sound-processing neural network 440. In these embodiments, a separate sound processor 425 is not used.

In still other embodiments, the sound processor 425 does not simply provide the sound data for a golf-swing portion identified by the video processor 420 to the sound-processing neural network, but rather does some operations to trim the sound data to a more precise range associated with the golf-club impact and/or golf-club swing, before providing the trimmed sound data to the neural network. The sound clips that the sound processor 425 trims in some embodiments are sound clips that it extracts from the storage set 415, while in other embodiments are sound clips that are extracted by the video processor 420. In some embodiments, the sound processor 425 analyzes the sound captured in each extracted clip for a precise moment of impact (since a video does not capture the exact moment of impact because not enough samples are taken compared to the speed of the swing) and the time stamps are used to more precisely interpolate the positions of the body parts, the club head and the shaft so that the analysis of the impact position is more precise.

The sound data that the sound processor provides to one or more neural networks is defined in the temporal domain in some embodiments, while it is defined in a frequency domain in other embodiments. When the sound data is provided in the frequency domain, the sound processor in some embodiments converts the sound data of the golf-swing video clips identified by the video processor from a time domain representation to a frequency domain representation.

The trimmed audio data (that is produced by the sound processor 425 in some embodiments, and the video processor 420 in other embodiments) only includes the swing and impact data, while leaving out residual and miscellaneous noises that occur before and/or after the swing. In some embodiments, the neural network 440 is trained to ignore these residual and miscellaneous noises and to only focus on the sound of the impact itself. In some embodiments, the residual noises are separated from relevant sound excluding the sound of the impact, such as the “swoosh” of the sound of the clubhead and shaft going through the air.

In some embodiments, the video processor 420 produces different video clips of the different golf swings that are in the captured video stored in the storage 415, and provides the produced video clips to a video-processing neural network 440 for analysis. Some embodiments train one or more neural networks to recognize body parts, such as a hand, as well as other relevant items such as a clubhead and the ball, in every frame of a video. In some embodiments, the video is turned into a swing arc over a period of time, including the timings of each frame in the arc. In some embodiments, a neural network 440 is able to provide analyses of different grips (i.e., grip positions used by a golfer) depicted in these frames, for example, in order to give key insights into swing faults.

In some embodiments, the video processor 420 also extracts metric data (e.g., swing speed, launch angle, etc.) from the video files to provide to the metric data processor 430. In other embodiments, the metric data processor 430 receives golf-swing data (e.g., time stamp data) from the video processor 420, and then uses the received data to extract metric data stored in the storage set 415 by the other capture devices 450 that capture and store metric data regarding golf swings in the storage set 415.

In still other embodiments, some of the metric data is produced by the video processor 420 while other metric data is produced by the metric processor after retrieving the metric data from the storage set 415, receiving the metric data from the video processor 420 and/or processing the received and/or retrieved metric data. The metric data processor 430 then provides the processed metric data to one or more neural networks for processing.

The other capture devices 450, in some embodiments, can include additional video capture devices (e.g., smart watches, smart phones, tablets, laptops, high-speed cameras, etc.), audio capture devices (e.g., smart watches, smart phones, tablets, laptops, etc.), specialty golf clubs, laser- or radar-based sensors, and pressure pads. In some embodiments, the data captured from the other capture devices 450 is used to enrich the video and/or audio data captured by the video capture engine 410. These other capture devices 450 store the captured data in the storages 415 for retrieval and processing by any of the processors 420-430.

The metric data processor 430, in some embodiments, processes metric data such as swing speed, swing path, ball speed, launch angle, ball spin direction, and ball spin rate. In some embodiments, the metric data processor 430 also computes a smash factor based on metric data from the video processor 420 and/or from the storage 415, and provides this value to the neural network 440 for use in further processing, while in other embodiments, the neural network 440 computes the smash factor itself. The smash factor is computed by dividing the ball speed by the swing speed (also referred to as the club speed or clubhead speed). In some embodiments, the metric data processor 430 processes metric data such as the distance the ball is projected to travel as computed by any of the other capture devices 450 (e.g., a swing simulator). The distance the ball is projected to travel is a function of swing speed, ball speed, swing path, ball speed, launch angle, ball spin direction, and ball spin rate as well as other factors.

Each neural network 440 in some embodiments includes multiple processing nodes as also described in the embodiments above. In some embodiments, one or more of the neural networks 440 is a convolutional neural network (CNN) or a hidden Markov model (HMM) network. After processing inputs, the neural networks 440 provide any outputs to output processors, such as any of the output processors described above by reference to FIGS. 1-3.

In some embodiments, the neural networks provide one or more assessments (e.g., analysis feedback and/or advice feedback as further described below) of each golf swing for which they receive audio, video and/or metric data. In other embodiments, the neural networks 440 provide their outputs to output processors (e.g., output processors 115, 215 and 315) that analyze the neural-network outputs and provide one or more assessments (e.g., analysis feedback and/or advice feedback as further described below) of each golf swing. For purposes of brevity, FIG. 4 does not illustrate the output processors (e.g., output processors 115, 215 and 315) as this figure is intended to illustrate the data extractors 420, 425 and 430. Examples of feedback include statistics about the analyzed swings, analysis feedback regarding whether a swing was “good” or “bad”, and advice feedback for improving future golf swings. In some embodiments, the output is provided as text, as audio (e.g., like a voice assistant), or as video (e.g., a video example for how to improve the swing).

Although FIGS. 1-4 illustrate machine-trained networks (e.g., neural networks) for processing sound, video and/or metric data related to golf swings, other embodiments do not use machine-trained networks but rather analyze the sound, video and/or metric data by using analytical programs (e.g., programs that use algorithmic approaches) to analyze the golf-swing data and provide assessments of the golf swings. Also, although FIG. 4 illustrates a video capture device (e.g., a video camera system) for capturing and storing a video of a golfer's training session, one of ordinary skill will realize that other embodiments do not use a video capture device, but rather just use an audio capture device, e.g., a microphone and associated audio processing software, to capture an audio recording of the training session. In these embodiments, the sound processor 425 analyzes the audio recording to extract individual audio clips of individual golf swings and then provides the extracted audio clips to the neural network(s).

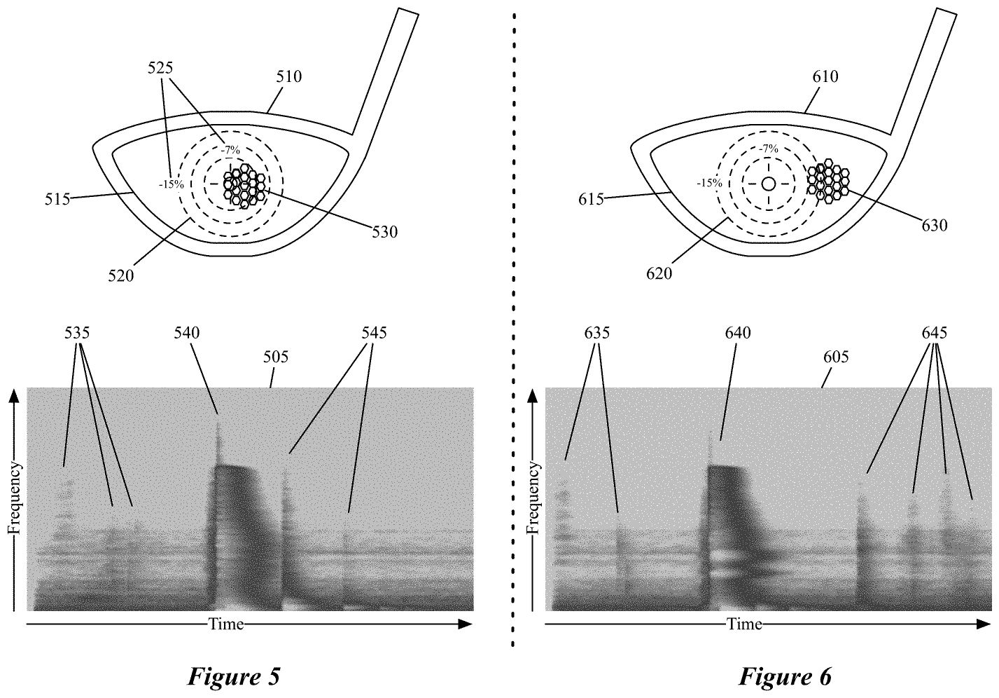

In some embodiments, the neural network is able to infer the point of impact of a golf ball on a clubhead based only on sound data (e.g., a spectrogram) associated with a swing. The neural network, in some embodiments, is able to do this due to correlations made between the sound data and data from impact tape that is only provided during the training. Impact tape is a sticky paper that can be placed on the face of the club (i.e., the portion of the golf club that strikes a ball). When the club is used to strike an object (e.g., a golf ball), the portions of the impact tape that have contact with the object, in some embodiments, is reflected by changes in appearance to the tape (e.g., gets darker, changes color, etc.). FIG. 5, for instance, illustrates a first example of a spectrogram that provides a visualization of the sound of a golf club striking a golf ball and a corresponding depiction of the impact tape on a golf club face reflecting where the golf ball came into contact with the club's face during impact.

It should be noted that the examples described and depicted in the embodiments herein are based on a golf driver hitting a golf ball off of a golf tee with a full swing for illustrative purposes. However, these embodiments are also applicable for any and all clubs, including woods, hybrids, irons, wedges, and putters, as well as any other hit off of any surface, including but not limited to off of any of the tee, a matt, grass, rough (tall grass), dirt, bunker, or any other surface, and with a full swing, ¾ swing, ½ swing, or any smaller controlled swings such as with chip shots or putting. Additionally, while the examples described in the embodiments herein demonstrate sound in the form of a visual representation of the spectrogram of the sound, the invention is not to be limited by such representations, and can include any form of representation of sound, such as the sound file itself, or any sound analysis in addition to, or instead of a frequency-domain analysis such as the spectrogram.

The impact tape 515 on the face of the golf club 510 includes a target 520 indicating where the ball was impacted by the clubface. This particular impact tape indicates concentric circles indicating how far off the center the ball was struck. As shown, a ball that strikes between the first and second rings may be “7%” off-center (i.e., compared to if the ball were to strike the center of the target 520), and by the outer third zone, “15%” off-center. The percentages may be somewhat correlated to distances lost by an average golfer with a consistent swing speed and swing path. The degree to which the impact position changes the distance or direction depends on many other factors such as the angle of the clubhead at the time of impact or swing speed or swing path. The sound of impact captures more than just the impact position. For example, the sound includes information about the amount of time the clubhead is in contact with the ball and whether the strike was a glancing blow or a sustained transfer of power to the ball. But as the existence of impact tape as a training aid indicates, impact position is a critical factor in improving the golf swing, and the ability to hit the golf ball in the middle of the clubface consistently is an important indicator of the skill level of the golfer. The present invention allows the sound of impact without the use of an impact tape to reliably predict the contact position on the clubface. The point of contact 530 on the impact tape in this example indicates the associated swing was likely a good swing, as the point of contact 530 is very near the direct center of the target 520 on the impact tape 515. The position of contact alone is not an indicator of how far the ball travels, but is an important factor in determining the quality of the swing in the ability to hit the “sweet spot” of the clubface to strike the ball.

Due to the significance of the point of contact on the clubhead, this metric is highly correlated with the sound produced by the impact. In some embodiments, the point of contact 530 is correlated with sounds on the spectrogram 505. For instance, in some embodiments, the data from the impact tape augments the sound of the impact (e.g., from a video) to train the neural network to associate specific sounds with specific impact positions, as mentioned above.

In some embodiments, the neural network is trained within a controlled environment. For instance, some embodiments use a swing simulator that includes a net or a screen for catching golf balls after they are struck. In some embodiments, as a result of the net being in closer range than where a golf ball may land on a golf course, additional sounds (i.e., apart from the club striking the ball, or the swoosh of the clubhead and shaft going through the air) can be picked up, like the ball hitting the net, or bouncing on the floor or ground afterwards and included in the spectrogram. A benefit of these additional sounds is that they can be used, in some embodiments, to further train the neural network to ignore any sounds that are not directly related to the impact between the clubhead and the ball. In other embodiments, these additional sounds, as well as background noise, are “subtracted” by analytical methods or by the neural network, or by use of another neural network.

The largest, darkest sound spike 540 in the spectrogram 505, for instance, represents the sound created by the impact between the clubhead and the golf ball, while the first sound spike 535 and last sound spikes 545 represent residual sounds before and after the impact. For instance, the last sound spikes 545, in some embodiments, may represent the sounds of the golf ball hitting a net and landing on the ground. Thus, training the neural network, in some embodiments, includes correlating the point of impact 530 on the impact tape 515 with the sound 540 on the spectrogram 505, and ensuring that the neural network does not consider the sounds 535 and 545 while evaluating the swing.

Alternatively, in some embodiments, the neural network may be trained to consider any sounds that occur immediately before the point of impact as these sounds may correspond to the clubhead hitting dirt or grass behind the ball (i.e., hitting the ball “fat” instead of “thin”). There are varying degrees of this such that even a decent swing and impact can have an element of being “fat” or “thin”, according to some embodiments, which affects the distance traveled by the ball after impact. The “fatness” or “thinness” can be seen on impact tape, in some embodiments, in addition to being audible on impact. In some embodiments, the neural network is also trained to account for differences between how this sounds on artificial turf compared to actual grass and other surfaces, and how these different surfaces may impact the swing. With some clubs, such as the irons or wedges, after the impact with the ball, a proper swing of the club may “take turf” which means that the leading edge of the club impacts the ball in a downward blow with the follow through action causing the dirt or grass on the target side of the ball to be shaved off. With other clubs, such as the driver or the putter, a proper swing of the club would not hit the dirt or the grass in any part of the swing. In some embodiments, the neural network is also trained to consider any sounds that occur immediately after the point of impact.

Once the neural network for the swing analyzer has been sufficiently trained, in some embodiments, the swing analyzer can be utilized without requiring impact tape, and the neural network can instead infer what the impact tape would look like based solely on the sound of the impact. In some embodiments, the swing analyzer can then provide suggestions and advice such as “stand ½ inch closer to the ball”. Such advice can be provided using text, in some embodiments, while in other embodiments the advice is provided using another medium, such as audio (e.g., like a voice assistant).

In addition to the impact tape, the neural network in some embodiments is trained by correlating sound data with data from other sensors, such as a video of the swing or a pressure pad. For instance, in some embodiments, to train the swing analyzer, swings are recorded as the person taking the swing stands on a pressure pad. In some embodiments, the pressure pad enables weight distribution of the person's feet to be visually recorded during the swing. Like the impact tape, the pressure pad would only be utilized for training the neural network of the swing analyzer, in some embodiments. Accordingly, during runtime of the swing analyzer, in some embodiments, the neural network would not have the benefit of data from the pressure pads, but may be able to infer weight shifts based on data from video sequences, and subsequently be able to diagnose weight shift issues based on the prior training with the pressure pads.

FIG. 6 illustrates a second example of a spectrogram that provides a visualization of the sound of a golf club striking a golf ball and a corresponding depiction of the impact tape on a golf club face reflecting where the golf ball came into contact with the club's face during impact. In this example, the point of impact 630 on the target 620 of the impact tape 615 that is placed on the clubhead 610 is much farther from the center than the point of impact 530 in the first example. In some embodiments, the point of impact 530 is indicative that the swing produced a “good” impact, while the point of impact 630 is indicative that the swing produced a “bad” impact.

In some embodiments, an impact that is mid-way between 330 and 230 is still considered to be a good swing with an acceptable result. Modern drivers (and clubs in general) have significantly expanded what is considered as the “sweet spot” of the golf club, which makes the club much more forgivable (i.e., results in a better impact and/or better results for swings that may otherwise be considered average or below average). Accordingly, while “good” and “bad” are used to characterize swings and resulting impacts in some of the embodiments described herein, it should be understood that various aspects of a swing, its resulting impact, and final results of that impact on the ball, can each be analyzed and assigned a degree of goodness based on a variety of factors and metrics collected and associated with the swing, impact, and final results

Like the spectrogram 505, the spectrogram 605 also includes sound spikes 635 before the impact point 640, and sound spikes 645 after the impact point 640. Training the neural network, in some embodiments, includes training the neural network to associate sound spikes similar to 540 with good swings, and associate sound spikes like 640 with bad swings. While the spectrograms 505 and 605 are grayscale spectrograms representing sound for the purpose of illustrating the concept in this disclosure, and constitutes a possible embodiment, in other embodiments the sound is represented or analyzed in other ways.

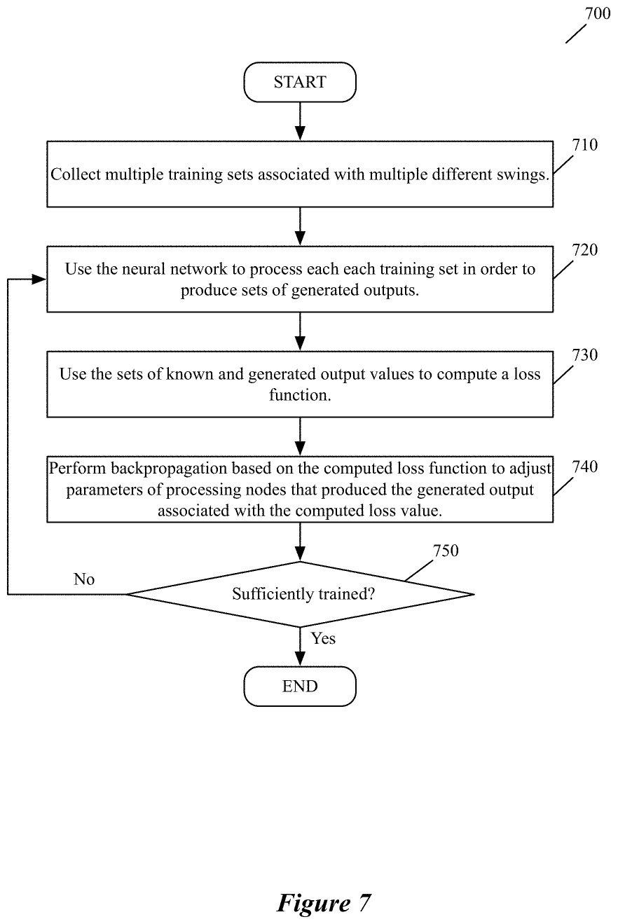

FIG. 7 illustrates a process performed to train a neural network to infer impact position (i.e., on a clubhead) from sound as input, in some embodiments. In some embodiments, the neural network is trained using deep learning algorithms that are hierarchically organized by increasing complexity, while other embodiments use more traditional machine learning algorithms that are linear to train the neural network, while yet other embodiments may use classical sound analysis without any neural networks.

The process 700 starts by collecting (at 710) multiple training sets associated with multiple different swings. Each training set, in some embodiments, includes multiple known input/output pairs, with each known input/output pair including at least sound (e.g., an audio file or stream of audio captured using a mobile device) produced by the swing and during the impact as the known input, and an impact position derived from impact tape on the clubhead used during the swing as the known output. In some embodiments, the training sets include additional data that are gathered from multiple sources, such as video, impact tape, pressure pads, and other sensors such as those from a smart watch. The audio file that captures the sounds that occur during a swing, particularly the impact, is generated from the video and included in the training sets, in some embodiments, and in other embodiments, the audio file is captured separately.

In some embodiments, the training sets also include training sets pairs with known inputs gathered from any of the sources listed above (e.g., video, impact tape, pressure pads, etc.) that correspond to known outputs provided by a human. For example, these human-provided known outputs can be numerical values, indications of whether certain data is associated with a good swing or a bad swing, indications as to what constitutes a “slice” (e.g., a ball that curves away from the golfer) and how it can be fixed, etc. The neural network is made up of multiple processing nodes with adjustable parameters, according to some embodiments. The adjustable parameters, in some embodiments, are weighted values that indicates the importance of a feature (e.g., a known input) and the relationship between the feature (e.g., the known input) and a target output.

In some embodiments, the process 700 uses (at 720) the neural network to process each training set in order to produce sets of generated outputs (i.e., generated by the neural network that processes known inputs included in the training sets). The generated outputs, in some embodiments, include predicted impact position based on sound data (e.g., audio files) included in the training sets as known inputs. In some embodiments, the neural network, or a separate neural network, is trained to use the predicted impact position as input to infer additional information (e.g., a second set of generated outputs) to be provided to the user as feedback. The feedback, in some embodiments, can include analysis feedback that indicates whether a particular swing was a “good” swing, a “bad” swing, or various degrees thereof, as well as advice feedback for improving future swings. For instance, a second set of generated outputs can include advice feedback that instructs a golfer move closer to or farther from the golf ball, in some embodiments.

The process uses (at 730) the sets of known outputs included in the training sets and the generated outputs generated by processing the known inputs included in the training sets to compute a loss function. Once trained, the neural network can infer impact position based on sound, for example from an audio file of sounds of the impact, without requiring data from an impact tape or some other impact sensors. The use of the known outputs in the training sets make the training of the neural network a supervised training/learning method.

The process performs (at 740) backpropagation for the computed loss function in order to adjust trainable parameters of processing nodes that produced the generated output. In some embodiments, the neural network adjusts its parameters (i.e., weights) based on the computed loss function. The parameters are adjusted, in some embodiments, in order to get the neural network to generate outputs that match the known outputs. Training neural networks through such back propagation operations is known in the art and any known technique for performing such back propagation operations or computing loss functions can be used in some embodiments to train the neural networks of some embodiments.

The process 700 determines (at 750) whether the neural network has been sufficiently trained. For example, the neural network is considered to be sufficiently trained, in some embodiments, when it is able to generate expected outputs and accurately infer, e.g., impact position on a clubhead based solely on the sound of the impact. When the process 700 determines that the neural network has not been sufficiently trained, the process 700 returns to use (at 730) the neural network to process each training set to produce sets of generated outputs. In some embodiments, the process 700 iterates through each of the training sets multiple times to train the neural network, according to some embodiments. Otherwise, when the process 30400 determines that the neural network has been sufficiently trained, the process 700 ends.

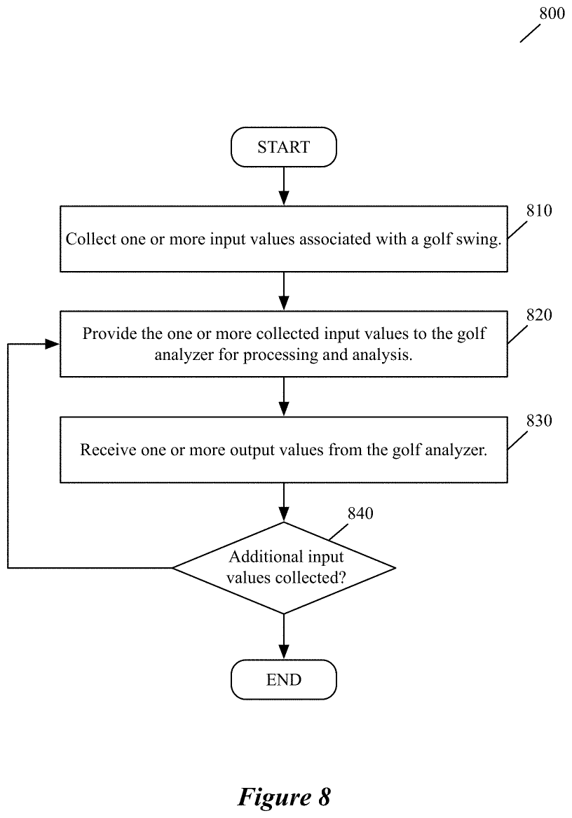

FIG. 8 illustrates a process performed by a swing analyzer to analyze a golf swing, in some embodiments. In some embodiments, the swing analyzer is a mobile application implemented on a user's mobile device (e.g., a smart phone, a smart watch, a tablet, or any combination thereof), and the process 800 is performed by the swing analyzer mobile application. The process 800 starts by collecting (at 810) inputs associated with one or more golf swings. In some embodiments, the inputs are an audio file of sounds produced during and by the one or more golf swings, or, e.g., a stream of audio through the user device on which the swing analyzer mobile application is implemented. In some embodiments, conjunctively or alternatively to the audio file, the inputs include a video of the one or more golf swings. The swing analyzer, in some embodiments, also accepts multiple videos of the same golf swing (e.g., videos from different angles, or a composite of such videos processed to create a “360-degree” model of the swing). In other embodiments, additional inputs are collected and provided as input for the swing analyzer, such as statistics collected from a launch monitor, pressure pad, or other sources (e.g., sensors in a smart watch worn by the golfer).

The process provides (at 820) the one or more collected inputs to the golf analyzer for processing and analysis. For instance, the capture devices described above in FIGS. 1-4 capture video, sound, and other data (e.g., by the other capture devices 450). In some embodiments, the swing analyzer includes a component for accepting live input (i.e., can access the camera functions of the mobile device) such that audio and/or video of a swing can be taken directly using the swing analyzer rather than providing a video recording to the swing analyzer after the fact. Different embodiments of the swing analyzer may accept videos taken in landscape mode, vertical mode, or both.

In some embodiments, the swing analyzer provides a start button through the swing analyzer's user interface, and when the user selects the start button (e.g., by using a finger to press an icon on a mobile device's touch screen), the swing analyzer listens (i.e., through the mobile device's microphone) for the user to provide a command that indicates the swing analyzer should start recording (e.g., when the user vocalizes “start”), while other embodiments may have the camera turned on as soon as the application starts and initiates recording only when the golfer gets in position with the clubhead behind the ball to start the (first) swing. In some embodiments, the swing analyzer records (i.e., video records) until a second command is provided by the user that indicates the swing analyzer should stop recording (e.g., when the user vocalizes “stop”). In other embodiments, the swing analyzer automatically stops recording after the requisite number (such as one, two, or three shots) of impact of the clubhead with the ball, not counting practice swings that may be in the video in between contacts.

The swing analyzer, in some embodiments, captures multiple impacts during the period. The swing analyzer instructs the golfer to swing as similarly as possible using the same club, perhaps with three impacts taken head on in landscape mode, and three more impacts taken down the line in portrait mode. In some embodiments, rather than a continuous video that includes multiple swings, the user can provide or record multiple separate videos of a set of swings as input for the swing analyzer. In other embodiments, a continuous video is taken for each of the camera angles, with the video analyzed to automatically clip the swing to multiple videos, one for each impact. In some embodiments, the impact is detected by audio analysis, which is faster, lower power, and more accurate than video analysis because audio is sampled much more frequently than images, but uses far less data. In some embodiments, the video is clipped by time, since most swings start and finish within 5 seconds, while in some embodiments, the video is clipped by image analysis. Since saving power on a mobile device is an important consideration, automatically clipping just the essential part of the swing video to transmit to the server, while perhaps retaining the entire video for later transmission, provides for longer battery life.

In some embodiments, the swing analyzer may provide instructions to the user regarding what input is required and/or desired for proper analysis. For instance, the swing analyzer in some embodiments may instruct a user to position the recording device (e.g., a mobile device such as a tablet, a laptop, or a smart phone, or a video camera) in a particular way (e.g., in landscape mode and facing the front of the user), and to attempt to capture a set of swings that are as identical to each other as the user can achieve (e.g., three swings while using the same club and standing in the same position). After this input is provided, in some embodiments, the swing analyzer may prompt the user to reposition the mobile device and record additional swings. For instance, the swing analyzer in some embodiments may prompt the user to record an additional set of swings with the mobile device in portrait mode instead of landscape mode.

Users with access to multiple recording devices that can be used simultaneously can use these multiple devices to capture videos of a single swing and resulting shot from various angles. For instance, such a user in some embodiments can use a first device to capture a head-on view of the swing and resulting shot, and use a second device to capture a down-the-line view of the same swing and resulting shot. Timestamps and/or sound extrapolated from the videos can then be used to sync the videos captured from the first and second devices and create a more robust view of the swing, according to some embodiments. Certain aspects, such as a golfer's posture at setup, are only visibly using a down-the-line view, in some embodiments, while the golfer's grip (i.e., hand grip) on the shaft of the golf club (e.g., the “V”s formed by the thumb and the index finger on both hands and pointing to the golfer's dominant shoulder), and shaft lean (e.g., “forward lean” meaning that the golfer's hands are closer to the target than the clubhead/ball at setup) are only visible from the head-on view. In some embodiments, a golfer relying on a single device for capturing swings can be prompted to capture, e.g., three videos from each perspective (i.e., down-the-line and head-on) with as similar a swing as possible in order to provide a good enough indication of the golfer's movements during the swings, as well as the movements of the club and target ball, without the benefit of two or more recording devices (e.g., cameras, mobile devices equipped with cameras, etc.) that are able to capture the same swing.

The process receives (at 830) one or more outputs from the swing analyzer after the swing analyzer has completed its processing and analysis of the provided inputs. The outputs, in some embodiments, can include various statistics associated with the swing, indications as to whether the swing was good or bad or degree of goodness, and feedback suggestions for improving the swing. For instance, during a good golf swing, the fastest part of the swing (where the “swoosh” would be heard in a practice swing) occurs after impact between the clubhead and the ball, in some embodiments. Accordingly, the swing analyzer, in some embodiments, can provide feedback suggestions such as “try to get the swoosh in front of you” when a user's current swings are determined by the swing analyzer to be fastest before impact.

In some embodiments, the swing analyzer also uses the inputs it receives over time for a user to determine a skill level for the user. For example, the swing analyzer in some embodiments may determine that a golfer has a higher skill level when the input associated with the golfer indicates there is little variation between the golfer's swings, and determine that a golfer has a more beginner skill level when the input associated with the golfer indicates there is a lot of variation between the golfer's swings.

The skill level, in some embodiments, affects the feedback suggestions provided as part of the output. For instance, for golfers that are more consistent between the swings, the advice may be more focused on correcting the nominal flight of the ball, such as the clubhead angle at impact, possibly corrected by the grip position at the start of the swing. For golfers that are more random between the swings, either in audio analysis which may indicate a more random dispersion of the projected impact tape position of the clubhead contact with the ball or in video analysis of the swing path, or grip, or follow through or the like, the advice may be more focused on creating consistency in the swing, such as taking the clubhead straight back for longer and creating a position at the top of the swing that is not “overswinging” with the club shaft beyond parallel to the ground, a “reverse pivot” where the golfer mistakenly swings the club up by contorting the body to tilt the body with the trailing hip away from the target rather than swinging around the body, or that the feet are not firmly planted during the backswing.

In some embodiments, the skill level can also affect the language used by the swing analyzer to provide the feedback suggestions. For instance, the swing analyzer may provide less detailed feedback and use more golf-related jargon for a golfer it determines has a higher skill level, such as “your hands are too active; body turn”, “chase the ball more”, “weight shift” or “too far inside on takeback”, while providing less technical, but more detailed feedback to a golfer that it determines to be a beginner, such as “apart from putting, a golf swing goes around your body horizontally like a baseball swing, but with your spine tilted down” or “Let the clubhead come from behind your hands; you want to pull the club into the ball with your hands ahead of the ball at impact” or “a golf swing is counterintuitive; to hit the ball up, you need to hit down on the ball; to hit it left, you need to swing inside to out; to hit it left, swing outside to in”.

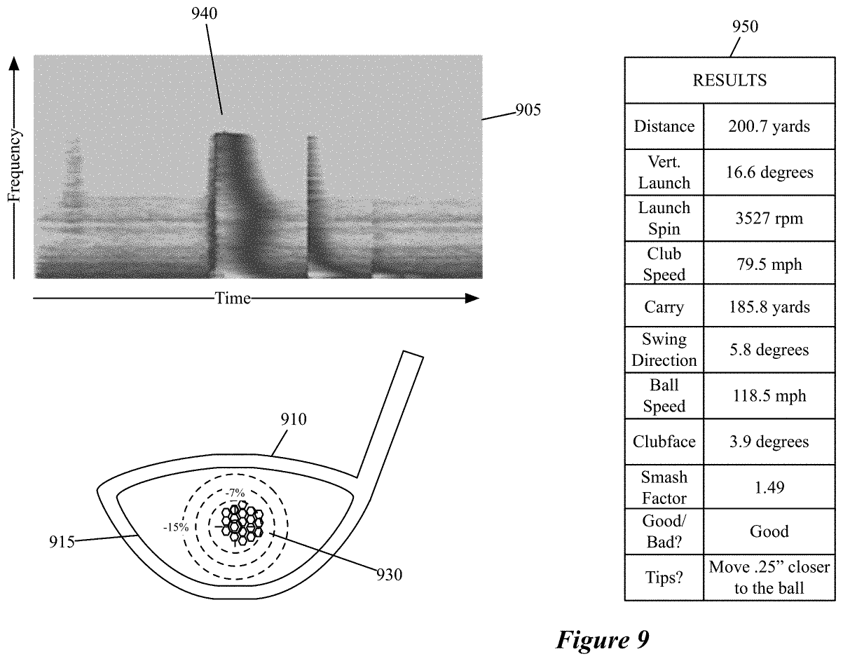

The outputs, in some embodiments, may be provided as text, audio, or video. In some embodiments, the outputs are numerical values that correspond to a lookup table that includes information associated with each numerical value. For instance, a user may receive a particular output value, and use the lookup table to identify the corresponding information, which can include suggestions for improvement such as instructing the user to adjust their stance in a particular way for the swing. An example of the output that can be provided, in some embodiments, will be described further below with reference to FIG. 9.

In some embodiments, the swing analyzer provides more than one set of outputs. For instance, the swing analyzer in some embodiments provides an immediate set of output data based on an analysis of only the less computationally intensive aspects, such as sound, that can be analyzed locally on the user's mobile device, and later provides a supplemental set of output data after the input has been processed by a server (e.g., cloud server) that includes a large database of information and data from multiple users of the swing analyzer. The present invention contemplates analysis both locally on the mobile device and on the cloud server to be any computation, including deep learning methods, or any combination thereof. Since power consumption on the mobile device is an important consideration, computing only audio, clipping the video to a short clip, then transmitting only the short clips to the server during the swing analysis session is useful. Further downloading of the entire video, which can include any practice swings performed in between shots and pre-shot routines, which are also more consistent in better golfers, provides additional information for the server processing, and further training to improve the neural network from the additional data that is possible on the server.

Feedback that includes advice feedback given as a result of the processing, in some embodiments, can be as simple as “you should do a rehearsal swing every time before you take a shot.” Also, in some embodiments, the training advice can be more statistical, such as “your second rehearsal swing didn't ‘stop and hold’ as well as the first one, and you repeated the worse rehearsal swing in your real shot.” The advice given in some embodiments can also be more specific about any aspect of the swing, for example “in your real shot, you took the club back way inside and had a much bigger takeback than your rehearsal swings.” This further downloading may be programmed to occur only when the mobile device is plugged in to a power source, perhaps as a user option.

The process then determines (at 840) whether there is any additional input that has been collected for another golf swing. When the process determines (at 840) that there is additional input, the process returns to 820 to provide the input to the swing analyzer. Otherwise, when the process determines (at 840) that there is no additional input for the swing analyzer, the process 800 ends. In some embodiments, the different impacts of a similar swing (as instructed to the golfer), including videos taken from different angles (such as head-on or down-the-line) are analyzed for similarity using the sound of impact as a discriminator. It is more likely that two swings that created the same impact sound and therefore similar impact position and similar result (such as distance the ball is projected to have traveled) are similar swings.

This statistical likelihood is used to analyze two different swings from, say, two different camera angles as though they were taken at the same time. In a professional golf simulation environment, down the line and head on views, and sometimes also top-down views are taken simultaneously for one swing. In a smart phone—based application (or other similar mobile device application), it is less useful to require multiple camera angles for the same swing, according to some embodiments. In other embodiments, video analysis may find similar swings taken from different angles, perhaps using analysis by neural networks, trained by taking videos of the same swings from multiple angles, then inferred to find similarities of different swings from different angles.

The present invention also contemplates deep learning, other algorithms, or a combination of deep learning and other algorithms inferring a 3D motion tracking of the golf swing from one angle. Such 3D motion tracking, in some embodiments, enables any other angle of a point of view to be inferred from just a single point of view. In some embodiments, additional inputs from sensors significantly enhance the extracted 3D motion tracking to be more accurate. Examples of such sensors, in some embodiments, include an accelerometer, a gyroscope, a compass, an ambient light sensor, and/or any other sensors on smart watches worn on the wrist of the golfer. The present invention additionally contemplates only these sensors, particularly in combination with the sound(s) of the swing and impact, to be sufficient to infer 3D motion tracking without the addition of any video.

In some embodiments, sound analysis is more consistent than video analysis, or analysis from any of the sensors mentioned above, because of the far higher sampling rates of audio, and, in some embodiments, is much faster because the data volume is far smaller (e.g., compared to the data volume of a video file). In some embodiments, sound analysis is first used to provide quick feedback to the user, while video and other analysis is later used, perhaps on the cloud server using more compute resources, to provide more detailed feedback, perhaps guided by the initial audio input. In some embodiments, both audio analysis and analysis based on data from sensors on a smart watch are first used to provide quick feedback, computed on a mobile device (e.g., mobile phone, smart watch, tablet, etc.). Since power consumption of the mobile device is an important consideration, in some embodiments, less processing on the mobile device is valuable.

FIG. 9 illustrates an example of sound analysis visualized in the form of a spectrogram, a diagram showing the point of impact on a clubhead, and a set of outputs, in some embodiments. In some embodiments where sound data is used as input in addition to the recorded sound itself, a higher resolution spectrogram enables the neural network of some embodiments to make more accurate inferences. In some such embodiments, options for selecting resolution are provided to a user to allow the user to decide which level of resolution they would prefer. In some embodiments, some other sound analysis replaces the spectrogram, while in other embodiments, other sound analyses are combined with spectrogram analysis. In this application, the word “spectrogram” is used to refer to any audio analysis, frequency-domain, amplitude-based, or otherwise. A visualization of a spectrogram is used for ease of discussion, and embodiments of the present invention may or may not include visualization of sound.

The spectrogram 905 of FIG. 9 provides a visualization of the sound that occurred during impact, as shown. The sound during the impact occurs over a short, but importantly varying duration of time. Marker 940 denotes the sound during that duration of the impact, which is associated with the area of impact 930 on the impact tape 915 of the clubhead 910. As mentioned above, the impact tape is used only in training the neural network, in some embodiments, and when training is completed, the neural network can infer the point of impact 930 based solely on the sound 940. Other embodiments, however, employ the impact tape or have specialty golf clubs, high speed cameras, and/or laser- or radar-based sensors that are able to capture similar, and/or additional data captured by the impact tape during training or during the use of the swing analyzer.

In addition to the sound analysis (depicted here as spectrogram 905) and impact tape 915, a set of results 950 that may be output by the neural network after processing at least the spectrogram 905 is illustrated. While the distance, vertical launch, launch spin, club speed, carry, swing direction, ball speed, smash factor, and clubface may include metrics that were known prior to processing by the neural network, any of these metrics may be outputs generated by the neural network, and other indications on quality of the swing (e.g., summarized as “good”, “average”, “fair”, “bad”, etc.), and tips, are all outputs generated by the neural network, in some embodiments.

In some embodiments, the outputs are categorized as metric outputs and feedback output. The feedback output, in some embodiments, includes analysis feedback and advice feedback. Analysis feedback can include the indications of the quality of the swing, impact, and/or resulting shot, in some embodiments, while the advice feedback can include tips and suggestions for improving the swing, impact, and/or resulting shot. It should be noted that whether a swing is good or bad is a grey area, and is also a function of the golfer, according to some embodiments. A 200 yard drive is great for some golfers, good for some other golfers, and potentially terrible for still other golfers (e.g., professionals). A gradation of the goodness of a swing is provided as part of the analysis feedback, in some embodiments.

The present invention also contemplates a quick feedback using only audio analysis performed on the mobile device immediately upon capturing the video (using the audio part of the video) to save battery power, and to process the data quickly for immediate feedback. In such modes, the immediate feedback being “Good Swing” vs. “Oops, not your best one” starts the coaching dialogue right away, buying time to the clipped video to be sent to the server to be analyzed and results returned to the mobile device. The analysis performed on the server may provide additional gradation of input such as “Best shot of the day. That probably went 230 yards.”, or “That ball did a banana curve on you again, right? You need to square up the clubface at impact. To do that, let's focus on being more rounded around the body.” It is anticipated that computing capability on mobile devices will continue to improve, particularly in the neural network capabilities. The present invention contemplates that more and more of the computing, including sophisticated video analysis will be practical on battery-operated mobile devices.

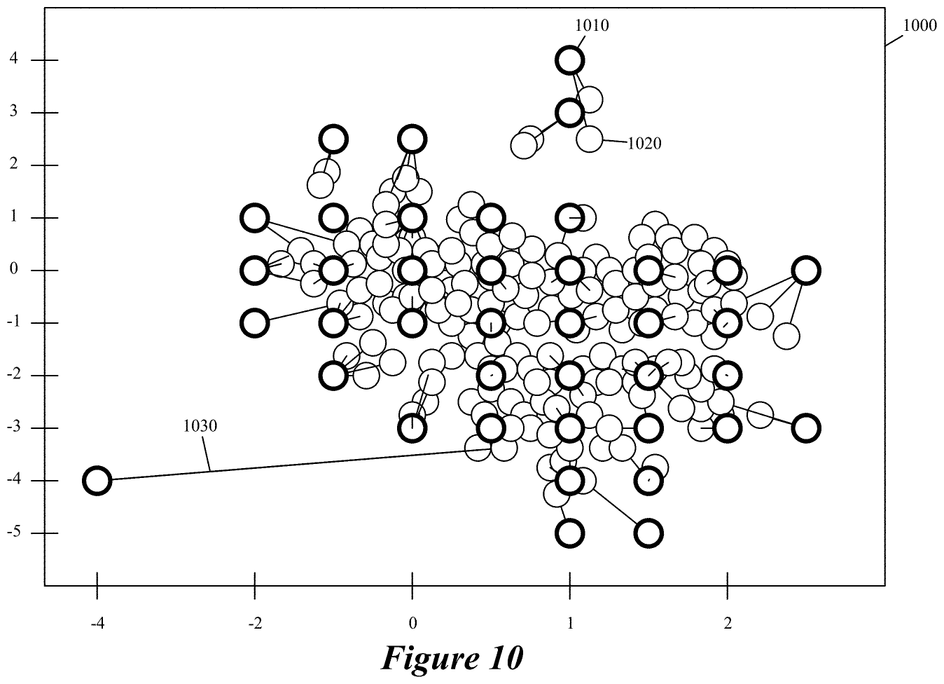

In some embodiments, the neural network is able to infer impact position based solely on the sound after training, and, in some embodiments, provides the inferred impact position for viewing in the form of a graph. FIG. 10 illustrates an example of impact position inferred by a neural network compared to actual impact position, in some embodiments. The actual impact position, in some embodiments, is determined using impact tape or other means for identifying impact position on a clubhead following a shot. As illustrated, the graph 1000 includes various nodes 1010 and 1020, with some nodes appearing connected by edges 1030.

In this example, the nodes having a thicker outline (i.e., nodes 1010) represent where impact tape would indicate the impact with a golf ball occurred. These thicker outlined nodes are quantized because they are based on manual extraction of impact position. The thinner outlined nodes 1020 represent what deep learning has inferred based on sound alone. Unlike the nodes 1010, the nodes 1020 are not quantized. The edges 1030 connecting some of the nodes 1010 to some of the nodes 1020 indicate how close the deep learning inferred impact positions are to the manually extracted impact positions. As such, shorter lines indicate that the deep learning was very close in its inferences, whereas longer lines indicate errors. Once the neural network has been trained, all of the edges 1030 should ideally be very short, indicating the neural network has successfully and accurately inferred impact position based solely on sound. That most lines are very short indicates that the particular neural network that inferred the impact position in this example was successfully trained to infer impact position from only sound as input.

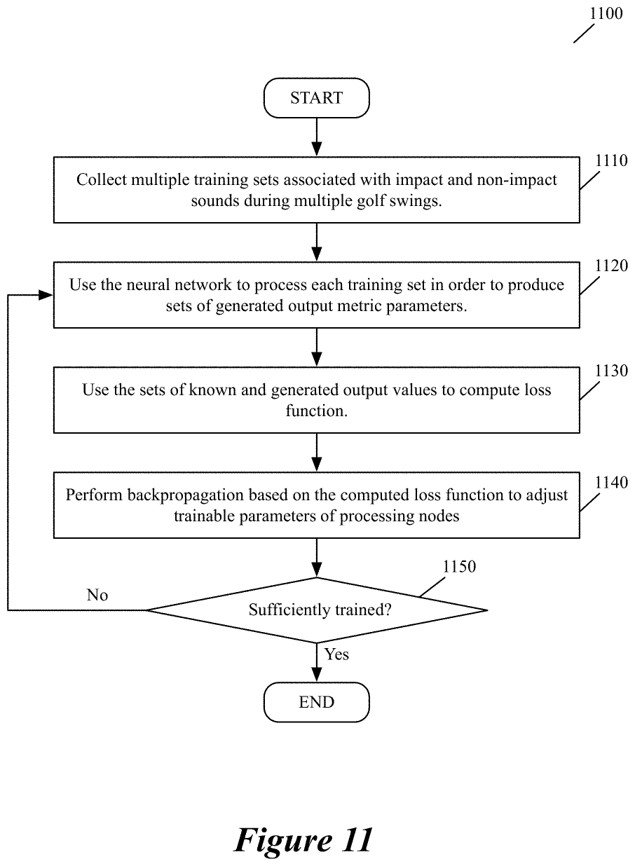

In some embodiments, different types of data are used in combination with sound and/or video data in training sets used to train the neural network to infer various output data. FIG. 11 conceptually illustrates a process of some embodiments for training the neural network to infer various metric data based on impact and non-impact sound data associated with golf swings. The process 1100 starts by collecting (at 1110) multiple training sets associated with impact and non-impact sounds during multiple golf swings. In some embodiments, these training sets are collected using a single device or multiple devices. For example, in some embodiments, multiple microphones may be placed near a golfer to capture sounds of the swings and related impacts. Also, in some embodiments, additional microphones may be placed far from the golfer to capture ambient sound. The multiple microphones, in some embodiments, are a part of a mobile device, such as a smart watch or a smart phone, or part of multiple mobile devices (e.g., one or more of any of smart phones, smart watches, tablets, etc.).

Additional devices, such as pressure pads for detecting weight shifts, radar guns for detecting club and/or ball speed, video recording devices for capturing swing arc, etc. are also used to collect the data included in the training sets, in some embodiments, to supplement the sound data (e.g., an audio file). The microphone in a smart watch is used, in some embodiments, for capturing sounds, while other sensors in the smart watch are used to capture other data. In some such embodiments, the swing analysis occurs entirely on the smart watch, including deep learning inferencing, collecting data, and outputting metrics, analysis feedback, and advice feedback. Also, in some such embodiments, the computing can occur on any of only the smart watch, only on a mobile device (e.g., a smart phone connected to the smart watch), only on a server connected to a mobile device by a communication method, or any combination thereof.

The training sets, in some embodiments, include sound recordings taken during the swings and videos of the swings, as well as metrics associated with the golf swings, such as distance (i.e., distance travelled by the ball after impact), various time stamps (e.g., timing of impact, duration of impact, total swing time, etc.), swing arc data (e.g., graphs of each swing arc), data from pressure pads that detect the golfer's movements and weight shifts during the swings, etc. The sound recordings are supplemented with a form of sound analysis, in some embodiments, such as visualizations of the sound (e.g., spectrograms, waveforms, etc.) or other analyses that are not visualizations generated from the recorded sound.

In some embodiments, additional data associated with the environment in which the golf swings were taken may also be included. For instance, in some embodiments, the golf swings occur within a controlled environment (e.g., an indoor space) where environmental factors are less likely to affect a swing or impact, while in other embodiments, the golf swings occur outdoors and can be affected by elements such as wind speed and direction. In still other embodiments, the golf swings include golf swings that occur within controlled environments as well as golf swings that occur outdoors.

Each training set, in some embodiments, has a number of pairs of known inputs and corresponding known outputs. In some embodiments, the known inputs include sound data (e.g., audio files) and/or video data (e.g., video files) associated with the golf swings, while the known outputs include metrics such as side spin of the ball, back spin of the ball, ball speed, club speed, direction (i.e., direction of the ball after impact), swing speed, swing path, launch angle, ball spin direction, ball spin rate, vertical launch, carry, swing direction, and smash factor.

In some embodiments, the metric data, as well as the predicted impact position, are a first set of outputs, and the neural network, or one or more separate neural networks, are trained to accept the first set of outputs as input in order to generate a second set of outputs. The second set of outputs includes feedback, including analysis feedback and advice feedback. In some such embodiments, the neural network, or multiple separate neural networks, are fed training data that includes pairs of known inputs (i.e., the first set of generated outputs) and known outputs that can include advice provided by a golf coach (e.g., “do not shift the hips toward the ball during the swing”).

A base set of advice feedback, in some embodiments, is used to form a generic set of advice given a swing fault (i.e., a fault in a golfer's swings that prevents golf-game improvements). In some embodiments, an additional set of advice feedback is used to further train the neural network for specific golf coaches, thereby providing a different specific advice engine for each coach. Each respective advice engine is further customized for the corresponding specific coach, in some embodiments, by using the coach's likeness, such as an animated likeness or a “deep fake”, and using the coach's voice, synthesized by text to voice trained on the coach's voice samples.

The process 1100 uses (at 1120) the neural network to process each training set in order to produce sets of generated outputs (e.g., output metrics). The neural network processes the training sets, in some embodiments, by extrapolating data from the known inputs included in the training sets to produce one or more sets of generated outputs. In some embodiments, the known inputs include sound data (e.g., audio files) associated with the golf swings (e.g., sounds of the golf club moving through the air, sound of the impact between the golf clubhead and golf ball, etc.). The known inputs, in some embodiments, are separated into subsets that include inputs associated with the golf swing before impact, during impact, and after impact, with each subset being processed separately by the neural network, or by separate neural networks trained for each different subset (i.e., a neural network trained for inputs associated with the time period before impact, a neural network trained for inputs associated with the time period during impact, and a neural network trained for inputs associated with the time period after impact), as will be described in more detail in the embodiments described below.

The process 1100 uses (at 1130) the sets of known outputs included in the training sets and the generated outputs to compute a loss function. Once trained, the neural network can infer the various generated outputs (e.g., metric outputs such as ball speed, swing speed, ball direction, etc.) based solely on sound recorded during swings as input, without any other input collected from other means (e.g., cameras, laser fields, pressure pads, radar, etc.). For instance, the neural network of some embodiments is trained to make inferences based on duration of the impact sound between the golf club and the golf ball, and frequency level of that impact sound. Such inferences (i.e., based on duration of impact and frequency level of impact) lead to generated metric outputs, such as swing speed and ball speed, according to some embodiments.

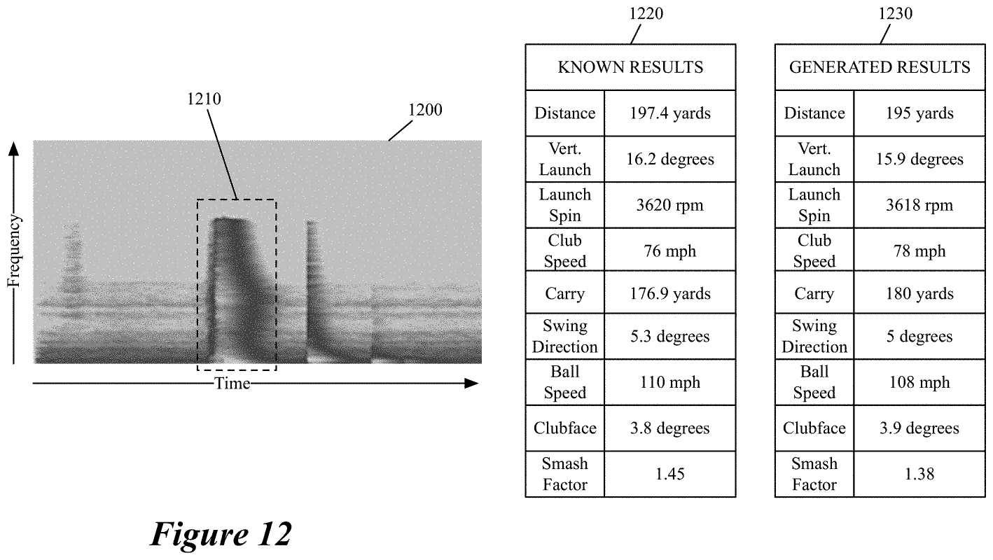

FIG. 12 conceptually illustrates an example of a spectrogram corresponding to sound used as known input for processing by a neural network and corresponding sets of known outputs and generated outputs, in some embodiments. As shown, the spectrogram 1200 provides a visualization of sounds during a swing, including the impact sound 1210. In some embodiments, the impact sound and sounds surrounding the impact are most useful for inferring and extrapolating the results 1230.

The training process 1100, in some embodiments, learns one generated output at a time. Also, in some embodiments, some or all of the generated outputs are trained in one process 1100. As shown, the known outputs 1220 and the generated outputs 1230 do not match, with each generated output varying slightly from the corresponding known output. Accordingly, each type of output in this example would have a corresponding error value. In other embodiments, only one or a select few of the generated outputs 1230 would not match the known outputs 1220. Also, other embodiments can include other outputs not shown either conjunctively, or alternatively to the outputs depicted. For instance, ball spin direction, back spin, and side spin are examples of other metrics that may be included in some embodiments.

Returning to the process 1100, the process 1100 performs (at 1140) backpropagation based on the computed loss function to adjust the trainable parameters of processing nodes. In some embodiments, the neural network adjusts its parameters (i.e., weights) based on the computed loss function and a learning function. The parameters are adjusted, in some embodiments, in order to get the neural network to generate outputs that match the known outputs.

The process 1100 determines (at 1150) whether the neural network has been sufficiently trained. For example, the neural network is considered to be sufficiently trained, in some embodiments, when it is able to generate expected outputs and accurately infer, e.g., impact position on a clubhead based solely on the sound of the impact.

When the process 1100 determines that the neural network has not been sufficiently trained, the process 1100 returns to use (at 1120) the neural network to process each training set to produce sets of generated outputs. In some embodiments, the process 1100 iterates through each of the training sets multiple times to train the neural network, according to some embodiments. Otherwise, when the process 1100 determines that the neural network has been sufficiently trained, the process 1100 ends.

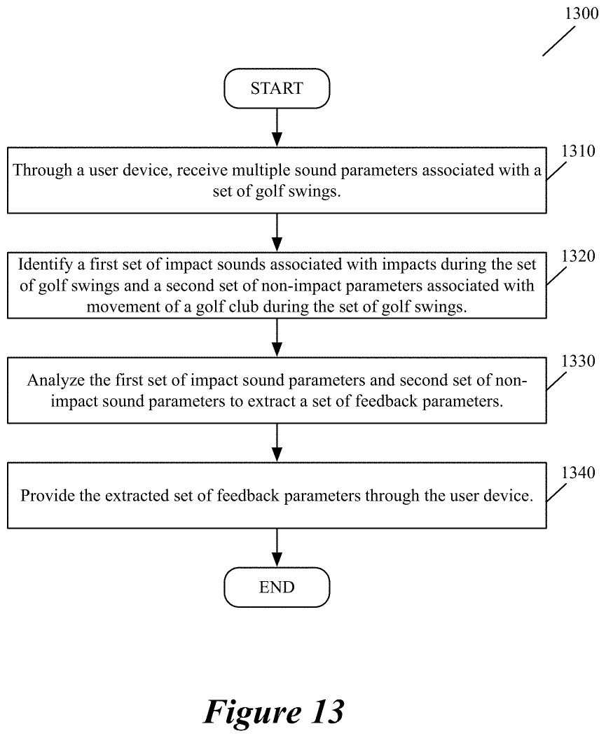

FIG. 13 conceptually illustrates a process of some embodiments for processing inputs that include both impact and non-impact sound parameters to produce output feedback parameters. The process 1300 is performed, in some embodiments, by a golf swing analyzer application operating on one or more user devices (e.g., mobile phones, tablets, portable computers, smart watches, etc.). In some embodiments, the golf swing analyzer application includes a trained neural network for performing the processing. The process 1300 starts when, through a user device, the process receives (at 1310) multiple inputs that include sound (e.g., in the form of one or more audio files) associated with a set of golf swings. In some embodiments, the golf swing analyzer application provides a prompt to the user to record audio and/or video of a particular number of golf swings (e.g., “record three swings”) before the swings will be analyzed. In other embodiments, the golf swing analyzer does not provide any prompts for a particular number of golf swings, and audio and/or video of a single golf swing, or any number of golf swings, can be provided as the inputs.

As described in embodiments above, audio of the swings can be recorded directly through the swing analyzer application in some embodiments, while in other embodiments the application requires an audio file that is recorded using another mechanism (e.g., an audio recording application on the user device) to be provided as input. In still other embodiments, the swing analyzer application includes an option to record directly through the application or to upload an audio file recorded outside of the application (e.g. using another application or another device).

The process 1300 identifies (at 1320) a first set of impact sounds associated with impacts during the set of golf swings and a second set of non-impact parameters associated with movement of a golf club during the set of golf swings. The impact sounds are sounds resulting from the impact between the golf club and the golf ball, in some embodiments, while the non-impact sounds are sounds before and after impact, such as the “swoosh” sound that occurs during some swings as the club moves through the air, according to some embodiments. Examples of other non-impact sounds captured in recordings and included as part of the second set of non-impact parameters, in some embodiments, include sounds produced from rehearsal swings in between shots, where there are sounds such as the “swoosh” without the sound of an impact. In some embodiments, as described above, the neural network that is part of the swing analyzer application is trained to ignore sounds unrelated to the swing and impact, such as keys rattling, people talking, wind noise, etc. In some embodiments, the neural network that is part of the swing analyzer application is trained to ignore sounds from other golfers hitting balls in nearby locations, such as the next stall in a golf driving range, or next to the golfer during play.

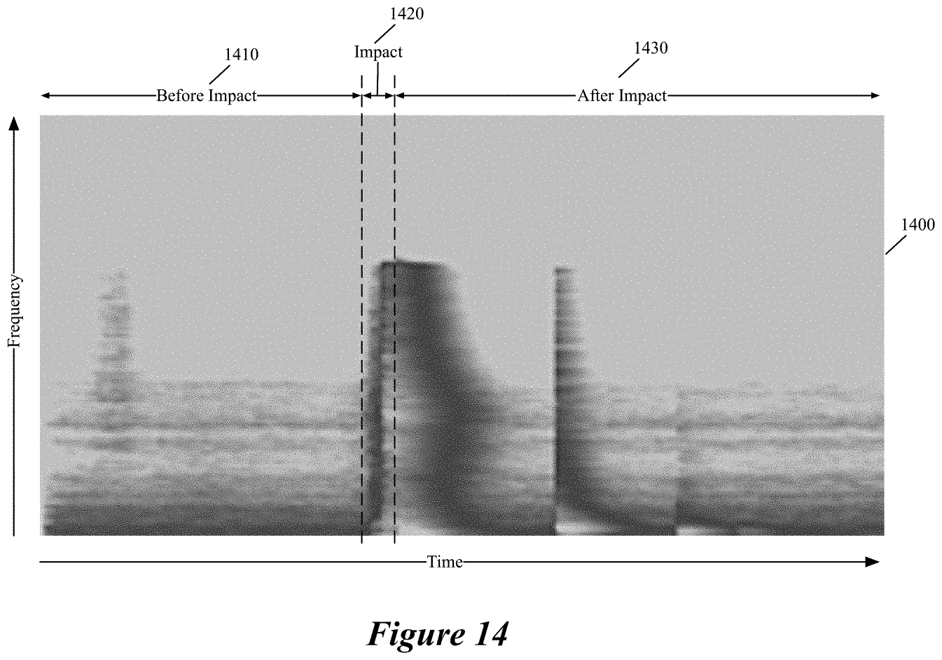

In some embodiments, the process 1300 identifies the impact and non-impact sounds by extrapolating sound data (e.g., in time-domain, frequency-domain, or any other domain) from the sounds (e.g., audio files) provided as input and identifying the impact and non-impact sound parameters from the extrapolated sound data, or any other result of sound analysis. Information available from sound produced during a golf swing, including sound produced by the impact between the golf club and golf ball, and resulting shot can be visualized with a spectrogram as an example, such as the spectrogram illustrated in FIG. 14.

As shown, the spectrogram 1400 illustrates sound as a function of frequency over time, with darker coloring representing higher amplitude, and lighter coloring representing lower amplitude. In this example spectrogram 1400, the sounds are divided into sounds before impact 1410, sounds during/at impact 1420, and sounds after impact 1430. The spectrograms illustrated and described in this application are a proxy for sound since audio files cannot be attached to an application. In one embodiment of the invention, a spectrogram or any other visualized depiction of sound can be used for image-processing applications, including neural network training and neural network inferencing. In other embodiments, sound data itself in time-domain, frequency-domain, or any other domain can be used.

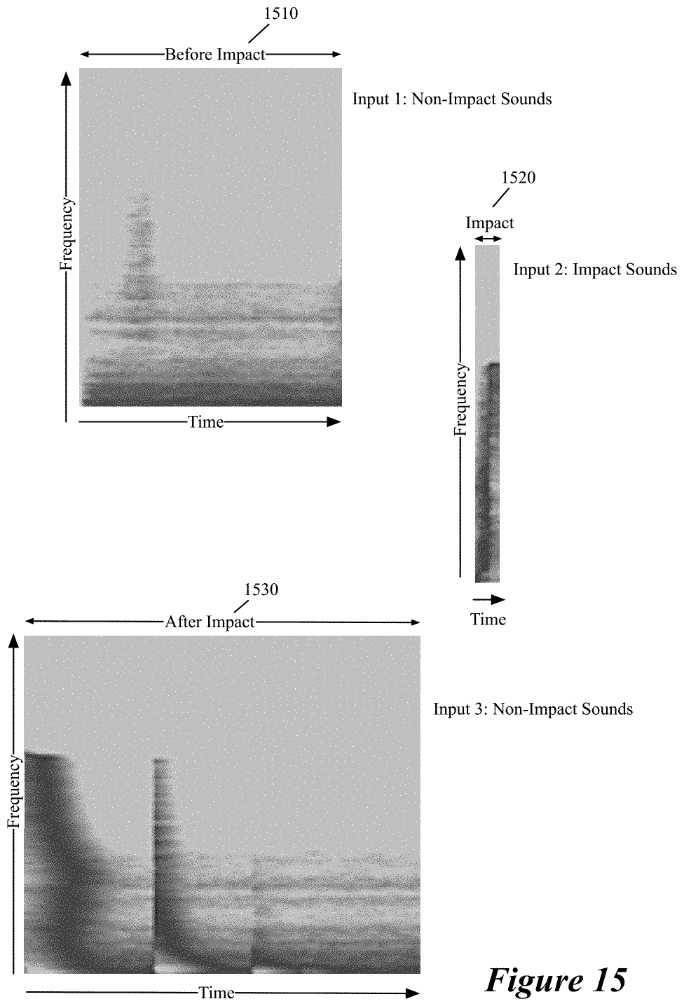

The swing analyzer application of some embodiments processes each subset of the sounds (i.e., before, during/at, and after impact) as separate input sets. For instance, FIG. 15 illustrates the spectrogram 1400 divided into different input sets, and identified as either “impact sounds” or “non-impact sounds”. The “before impact” portion 1510 includes non-impact sounds that occur before the club strikes the ball. These sounds, in some embodiments, include non-impact sounds of the club traveling through space (i.e., moving through the air) as the golfer starts their swing and the club (presumably) accelerates. The “impact” portion 1520 includes the sound during the impact between the club and the golf ball and is identified as “impact sounds”. In some embodiments, duration of impact is correlated with swing speed and/or ball speed. Lastly, the “after impact” portion 1530 includes additional non-impact sounds that occur after the ball has been struck. These sounds, in some embodiments, include additional sounds of the club as it moves through space and (presumably) decelerates until it comes to a halt. The sounds may also include additional sounds of the ball as it moves through space. Additional post-impact sounds can include the ball landing on the ground (e.g., when the ball does not travel very far or hits a net during practice swings). In some embodiments, as will be discussed in more detail below, these post-impact/non-impact sounds can include the “swoosh” of the club as it reaches its top speed during the swing.

Returning to the process 1300, the process 1300 analyzes (at 1330) the first set of impact sound parameters and second set of non-impact sound parameters to extract a set of feedback parameters (i.e., generate outputs). As described above for the processes 700 and 1100, the neural networks of some embodiments are trained to infer a variety of information from impact and non-impact sounds that are provided as input, such as impact position on a club head and various metrics associated with the golf swing or swings (e.g., swing speed, ball speed, ball spin direction, smash factor, etc.). As also mentioned above, in some embodiments, the outputs resulting from this processing are subsequently used as inputs to produce a second set of outputs. Examples of the second set of outputs of some embodiments include analysis feedback, such as ratings (e.g., good, fair, average, etc.) of the golf swing or swings, and advice feedback, such as suggestions for improving future swings (e.g., “move ¼ inch closer to the ball by moving your feet: don't reach”).

The process 1300 provides (at 1340) the extracted set of feedback parameters through the user device. For example, FIG. 9 described above illustrates the results 950 provided to a user, in some embodiments. In some embodiments, a first portion of the results are provided through the swing analyzer application on the user device or devices, and a more detailed second portion of the results are provided separately, such as by clicking into a “details” page, by being displayed in a webpage, or sent to the user electronically. In some embodiments, one or both portions of the results include advice feedback, virtually coaching a suggested fix to a detected fault in the swing as computed on the user device or devices. The results, in other embodiments, are provided to the user as a single set of results through the user device.

As described above and will be further described below, only a first subset of the inputs are processed on the user device or devices, in some embodiments, while a second subset of the inputs are sent to a centralized server or cloud-based analytics engine that has more computing power and can perform a more in-depth analysis that results in more detailed outputs, such as more detailed analysis feedback as well as more detailed advice feedback. Also, in some embodiments, both the second subset of inputs and any generated outputs resulting from processing the first subset of inputs are provided to the centralized server or cloud-based analytics engine to produce the more detailed analysis and advice feedbacks. Following 1340, the process 1300 ends.

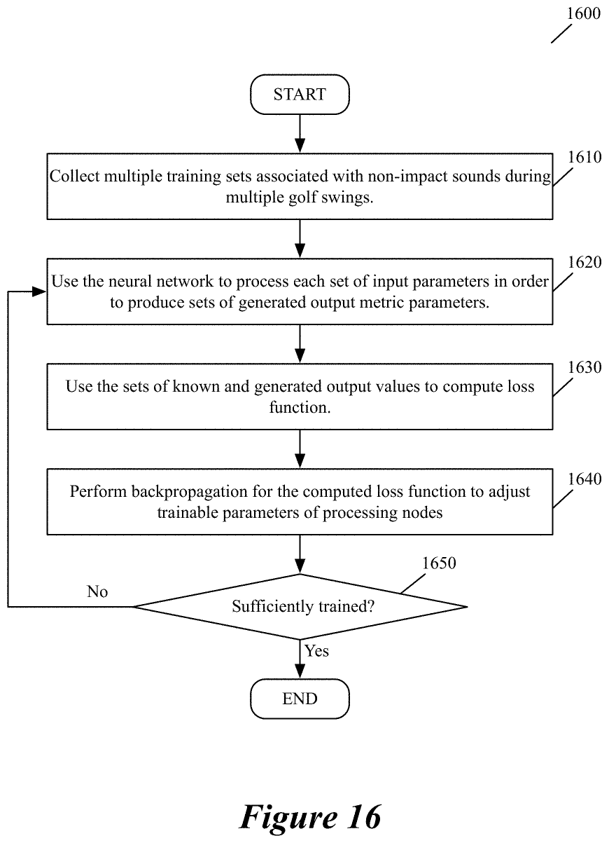

FIG. 16 conceptually illustrates a process of some embodiments for training a neural network to infer data associated with golf swings based on non-impact sounds during the golf swings. The process 1600 starts by collecting (at 1610) multiple training sets associated with non-impact sounds during multiple golf swings. In some embodiments, the multiple training sets include data associated with multiple golf swings that each include an impact in order to train the neural network to separate the non-impact sounds from sound data (e.g., sound files) that also includes impact sounds. For instance, before and after impact portions 1510 and 1530 in FIG. 15 described above are portions of the spectrogram 1400 that are associated with non-impact sounds. These non-impact sounds, in some embodiments, also include the “swoosh” sound that occurs around the time of impact.

The process 1600 provides (at 1620) the multiple training sets to a neural network. Each training set has a number of pairs of known inputs and corresponding known outputs, in some embodiments. The known inputs include sound data (e.g., audio files) and/or video data (e.g., video files) associated with the golf swings, in some embodiments, while the known outputs include metrics that can be inferred from non-impact sounds. For instance, a “swoosh” that occurs before an impact or estimated impact (e.g., during practice swings where there is no impact with a ball) indicates a below-average swing, whereas a “swoosh” that occurs with and following an impact indicates an average or above-average swing, according to some embodiments. That is, the “swoosh” occurs, in some embodiments, as a result of acceleration of the club, and thus striking the ball when the club reaches its top speed, rather than during the club's deceleration, leads to average and above-average swings.

By training the neural network to identify and understand the non-impact sounds of a swing that includes an impact, the neural network of some embodiments can later make inferences to predict what effect(s) a “shadow” swing that does not impact a ball would have on a ball, if the same swing were to impact a ball. This allows the swing analysis capability to provide feedback (e.g., analysis feedback and advice feedback) to users who may not have access to an environment where a golf ball or other target ball object can actually be hit. For example, in some embodiments, the input also includes parameters associated with arcs of the swings (e.g., extrapolated from any videos capturing the swings), and the neural network is trained to correlate the timing of the “swoosh” sound with club position within the swing arc such that even if the swing is a practice swing that is not intended to hit a target, timing of the impact and quality of the swing can still be inferred based on where in the swing arc the “swoosh” occurs (i.e., before or after the club reaches the bottom of the swing arc).

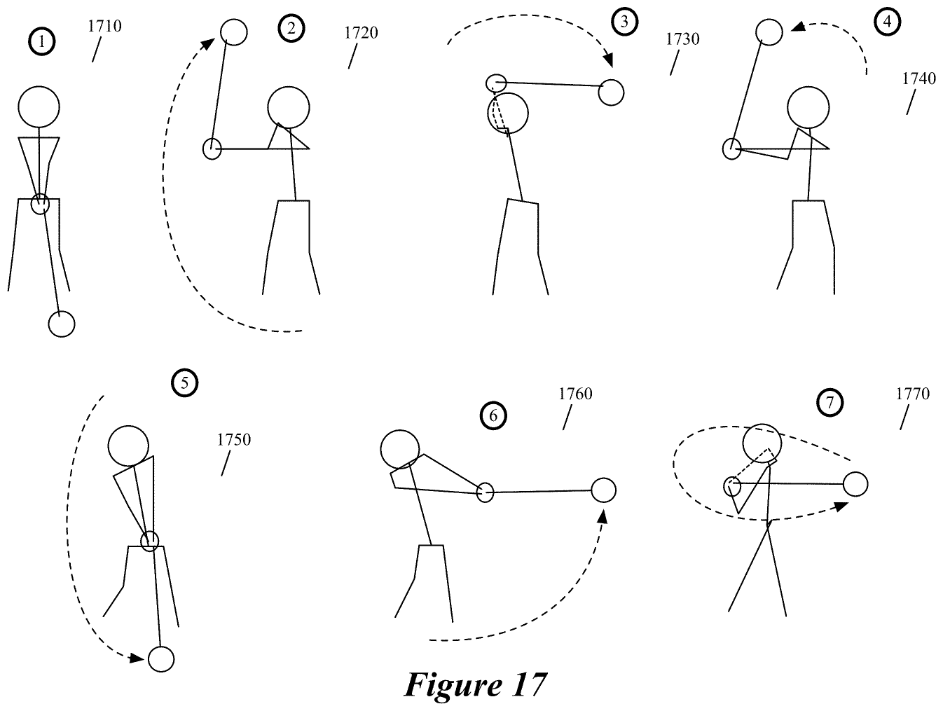

FIGS. 17-15 conceptually illustrate examples of a swing arc and associated spectrogram produced from sounds recorded during a swing and resulting shot, of some embodiments. FIG. 17 conceptually illustrates a series of stages of a swing, in some embodiments. As shown, at the first stage 1710, the figure is teeing-up (referred to as “at address”). In some embodiments, the grip position of how each of the golfer's hands grips the club at address is analyzed to provide analysis feedback and advice feedback. In some such embodiments, the hand grip analysis is used in combination with other neural network inferencing to provide the analysis feedback and advice feedback.

Once the figure is at address, the figure then brings the club back and up in the second stage 1720 and third stage 1730 as the figure performs the backswing. The clubhead comes to a momentary stop at or following 1730 as it changes direction. The swing arc begins at the fourth stage 1740 as the figure begins to bring the club back down and around. Based on club position and body position of the figure, it can be surmised that an impact or estimated impact (i.e., for practice swings that do not involve any targets) occurs at the fifth stage 1750, with the clubhead located at or near the bottom of the arc. With drivers (i.e., the type of golf club), for instance, the bottom of the arc is not where the ball is impacted, as the ball is teed up higher than the arc, according to some embodiments.

In the sixth stage 1760, the club has completed impact or estimated impact (e.g., for practice swings), and the swing is completed at the seventh stage 1770. For an ideal swing, the club is accelerating from the third stage 1730 through the fifth stage 1750, and begins decelerating at or after fifth stage 1750, before the sixth stage 1760.

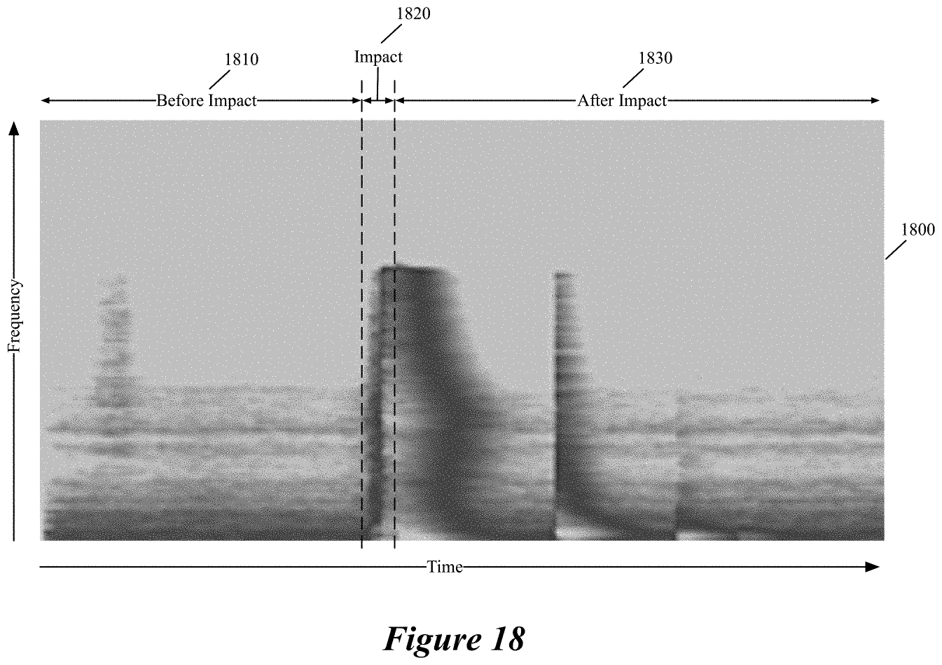

FIG. 18 illustrates a spectrogram 1800 of some embodiments, divided into three sections based on timing of impact. As shown, the start of the after impact portion 1830 includes a loud sound that continues from the impact 1820. In some embodiments, this sound includes the “swoosh” of the golf club moving through the air. Because the “swoosh” is after the impact and not before for an expert golfer, the neural network of some embodiments is trained to correlate the fifth stage 1750 of the swing arc in FIG. 17 with the impact sound 1820 in the spectrogram 1800, as well as to infer that the “swoosh” sound occurs during and/or between the fifth and sixth stages 1750-1760 of the swing arc, according to some embodiments. Average golfers and expert golfers are very different in the progression of swing speed through the swing. This is an example of sound that is not the impact sound that provides important indication of the quality of the swing.

The process 1600 uses (at 1630) the neural network to process each training set in order to produce sets of generated outputs. The process 1600 then uses (at 1640) the sets of known outputs included in the training sets and the sets of generated outputs to compute a loss function (e.g., based on the differences between the known outputs and the generated outputs). Training the neural network is done with impact and non-impact sounds, or results of sound analysis such as can be visualized by spectrograms, but in process 1600, the objective is to learn as much as possible about characteristics of an impact that would have resulted in a swing that does not actually hit a ball, and therefore lacks impact sounds. Other data from other sources of data about a swing that did not hit a ball, such as radar, laser fields, cameras, or sensors such as from smart watches on the movement and rotation of the wrist through the swing, is augmented by the result of the inference of this neural network in some embodiments. In some embodiments, the neural network itself has data from these other sources of data as additions to the training sets at step 1610 described above. In some embodiments, the neural network processes non-impact sounds that occur before impact and after impact separately, while in other embodiments, all non-impact sounds are processed together. The training of the neural network is used for inferring and extrapolating certain data and information from input sound parameters without the use of additional input.

The process 1600 performs (at 1640) backpropagation based on the computed loss function to adjust trainable parameters of processing nodes of the neural network. In some embodiments, the neural network adjusts its parameters (i.e., weights) based on the computed loss function and a learning function. The parameters are adjusted, in some embodiments, in order to get the neural network to generate outputs that match the known outputs.

The process 1600 determines (at 1650) whether the neural network has been sufficiently trained. For example, the neural network is considered to be sufficiently trained, in some embodiments, when it is able to generate expected outputs and accurately infer, e.g., impact position on a clubhead based solely on the sound of the impact.

When the process 1600 determines that the neural network has not been sufficiently trained, the process 1600 returns to use (at 1630) the neural network to process each training set to produce sets of generated outputs. In some embodiments, the process 1600 iterates through each of the training sets multiple times to train the neural network, according to some embodiments, e.g., until the computed loss values are either negligible, or within an acceptable range of error. In some embodiments, large numbers of iterations are required to properly train the neural network. Otherwise, when the process 1600 determines that the neural network has been sufficiently trained, the process 1600 ends. In some embodiments, the process 1600 is performed separately from, or in conjunction with the processes described above and below for training the neural network or neural networks.

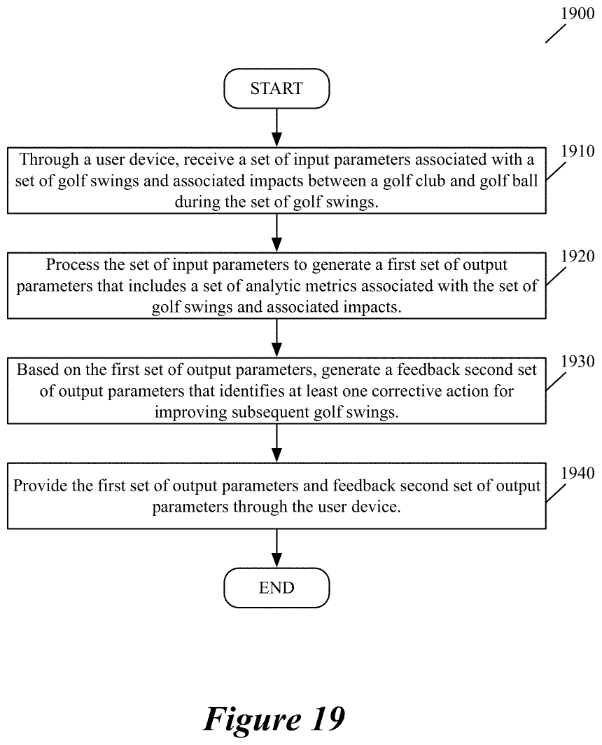

FIG. 19 conceptually illustrates a process of some embodiments for providing feedback as output. The feedback, in some embodiments, includes analysis feedback (e.g., regarding the quality of the swing(s) and/or resulting shot(s)) and advice feedback (e.g., suggestions for improving future swings and resulting shots). In some embodiments, different forms of analysis feedback and advice feedback are provided, including modifications of the language used in the feedback based on a skill level of the golfer. The skill level of the golf is determined, in some embodiments, by classifying golfers based on the amount of statistical variation between different golf swings in a set of golf swings performed by the golfer. It should be noted that in some embodiments, different options for providing input that is associated with different types of golf clubs (e.g., drivers, irons, putters, etc.), different brands of golf clubs that use different materials, etc., are provided and can affect the output generated. That is, in some embodiments, the neural network is trained for a variety of different club types, and thus can accept different input based on club types. In some embodiments, separate neural networks are trained for each club type, or a grouping of club types.

The process 1900 is performed in some embodiments by a golf swing analyzer application operating on a user device (e.g., mobile phone, smart watch, tablet, portable computer, etc.). In some embodiments, the golf swing analyzer application includes a trained neural network for performing analysis and processing inputs to generate outputs. The process 1900 starts when through a user device, the process receives (at 1910) a set of inputs associated with a set of golf swings and corresponding impacts between a golf club and golf ball during the set of golf swings. The inputs, in some embodiments, include sound and/or video. In some embodiments, in addition to the sound and/or video, other inputs such as sensor parameters (e.g., from a smart watch) are also included. The inputs, in some embodiments, include sound, video, data from sensors, data from laser fields, data from radar, data from pressure-sensors, or any combination of these example inputs, for example, in an application that acts to augment an existing swing analysis solution.

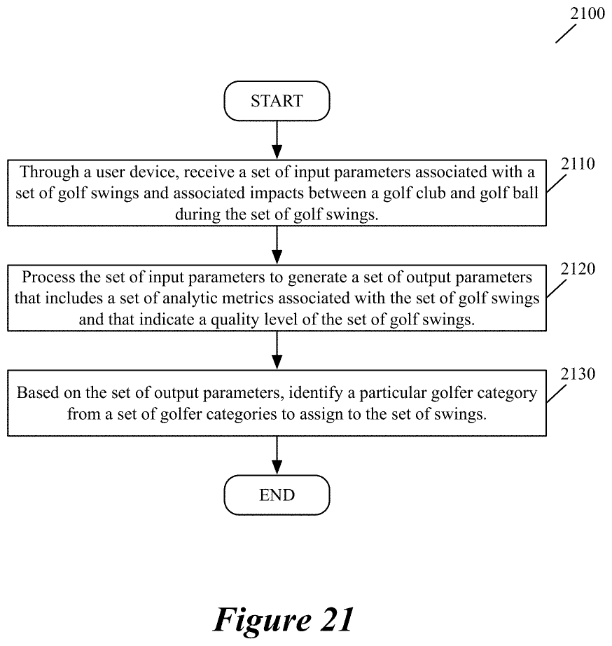

The process 1900 processes (at 1920) the set of inputs to generate a first set of outputs that includes a set of analytic metrics associated with the set of golf swings and corresponding impacts. The golfer is asked to make multiple swings with the intention of each swing being as identical to each other as practically possible for that golfer, in some embodiments. Good golfers tend to be more consistent as described below in FIG. 21. The analytic metrics, in some embodiments, can include distance, vertical launch, launch spin, club speed, carry, swing direction, ball speed, clubface angle, smash factor, or any other metrics that the neural network is trained to infer and extrapolate from the provided inputs.

Based on the first set of outputs, the process 1900 generates (at 1930) a feedback second set of outputs that can include analysis feedback, advice feedback, or both. Analysis feedback, in some embodiments, corresponds to what happened with the swing, both good and bad. For example, in some embodiments, the analysis feedback can include commentary such as “you're taking the club back too far inside” or “your second swing was the best”. Advice feedback, in some embodiments, can include suggestions about what to do next, such as “keep doing that” and, in some embodiments, also includes a corrective action for improving subsequent golf swings, such as “remember to drag the club straight back on take away”, “even more”, or “try to remember the second swing and repeat that”. In some embodiments, the neural network used to infer analysis feedback is separate from the neural network used to infer advice feedback. In some embodiments, generating the feedback second set of outputs includes comparing the first set of outputs to a set of threshold values, or ranges of values, that are used to define a set of categories that influence the content of the feedback second set of parameters.

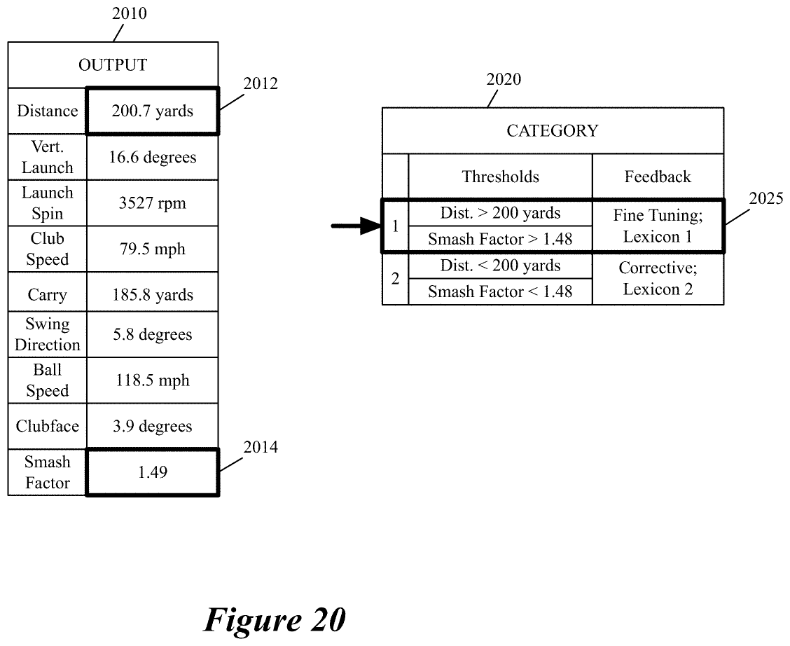

For example, FIG. 20 conceptually illustrates an example of a set of outputs of some embodiments and a set of categories defining thresholds for a subset of outputs to use to determine the feedback second set of outputs of some embodiments. As shown, the outputs 2010 include distance, vertical launch, launch spin, club speed, carry, swing direction, ball speed, clubface angle, and smash factor. The categories 2020 includes two categories defined by thresholds for distance and smash factor. It should be noted that the outputs 2010 and categories 2020 are exemplary and other embodiments can include outputs not illustrated in the outputs 2010 and other categories defined using other thresholds and/or ranges conjunctively with, or alternatively to those illustrated.

The first of the categories 2020 is defined for distances greater than 200 yards and smash factors greater than 1.48, and specifies advice feedback that should include fine tuning and use a first lexicon, while the second of the categories 2020 is defined for distances less than 200 yards and smash factors below 1.48, and specifies advice feedback that should include corrective actions and use a second lexicon. In some embodiments, the first lexicon is geared for golfers that are more experienced and more familiar with golf-related jargon, whereas the second lexicon is geared toward beginners and relies on more basic language. Based on the distance 2012 of 200.7 yards and smash factor 2014 of 1.49 indicated in the outputs 2010, the first category 2025 is used to determine the feedback second set of outputs in this example, indicating the golfer associated with the swing is more experienced and requires fine tuning rather than more elaborate corrections. In some embodiments, lexicon is chosen by categorizing the golfer in this way, or by analyzing the variation as described below, or by the user's handicap or self-declaration, or simply by user option in the swing analysis application, or any combination thereof.

Returning to the process 1900, the process 1900 provides (at 1940) the first set of outputs and feedback second set of outputs through the user device. In some embodiments, some or all of the feedback is provided audibly using a speaker or a listening device of the user device (e.g., through a voice assistant implemented within the swing analyzer application) similar to what a human golf coach can provide. In other embodiments, all of the outputs including the feedback parameters are displayed by the application through the user device. In some embodiments, the application is implemented on multiple user devices, such as a mobile telephone and a smart watch that includes a speaker or other listening devices and a microphone, and some or all of the feedback is generated on the mobile telephone and provided as audio via the speaker of the smart watch or a listening device connected to the mobile telephone. Following 1940, the process 1900 ends.

FIG. 21 conceptually illustrates a process of some embodiments for categorizing a golfer based on a quality level determined for a set of golf swings associated with the golfer. The process 2100 is performed in some embodiments by a golf swing analyzer application operating on a user device (e.g., mobile phone, smart watch, tablet, portable computer, etc.). In some embodiments, the golf swing analyzer application includes a trained neural network for performing analysis and processing inputs to generate outputs. The process 2100 starts when through a user device, the process receives (at 2110) a set of inputs associated with a set of golf swings and corresponding impacts between a golf club and golf ball during the set of golf swings. In some embodiments, the inputs include sound, video, or a combination of both sound and video. As described above, the inputs of some embodiments can also include inputs from other sources, such as sensors in a smart watch.

The process 2100 processes (at 2120) the set of inputs to generate a set of outputs that includes a set of analytic metrics associated with the set of golf swings and that indicate a quality level of the set of golf swings. Like the outputs described above for the process 1900, the outputs of some embodiments can include metrics such as distance, ball speed, club speed, launch angle, launch spin, carry, and any other metrics that the neural network is trained to infer and extrapolate from the provided inputs. In some embodiments, variation among the different swings in the set (i.e., as evidenced by the outputs) is used to determine the quality level.

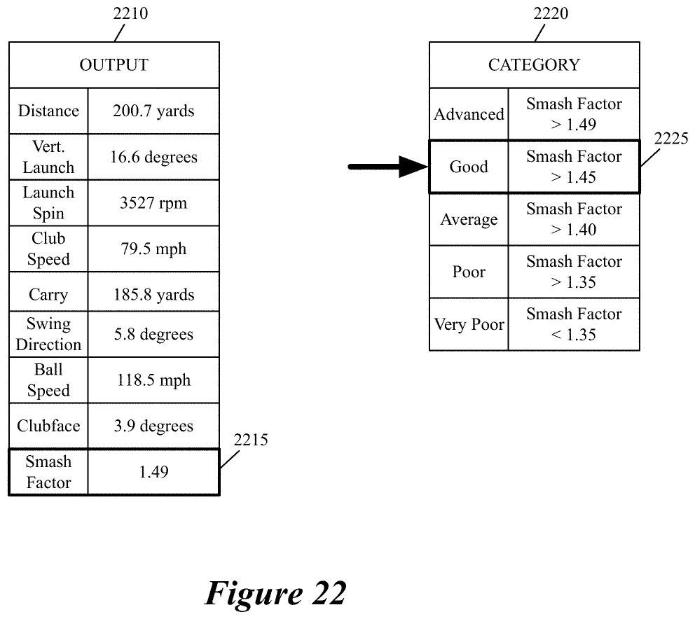

Based on the set of outputs, the process 2100 identifies (at 2130) a particular golfer category from a set of golfer categories to assign to the set of swings. In some embodiments, the golfer categories are defined in a lookup table and the process uses the lookup table to identify and provide the golfer category. Following 2130, the process 2100 ends. In some embodiments, the golfer category is the same as the categories described above for FIG. 20, while in other embodiments, the golfer category is separate. In some embodiments, the golfer category continues to be refined as more data becomes available through acquisition of more swing data, or other input, such as the golfer's handicap, scores, data gathered during a round of play, or self-declaration of the golfer's playing ability input through any user interface on any device. FIG. 22 conceptually illustrates an example of a set of outputs and a set of categories defined according to at least one of the outputs.

As shown, the categories 2220 in this example are defined according to smash factor, which is computed using swing and ball speed. In this example, the advanced category includes swings having smash factors greater than 1.49, the good category includes swings having smash factors of greater than 1.45, the average category includes swings having smash factors greater than 1.40, the poor category includes swings having smash factors greater than 1.35, and lastly the very poor category includes swings having smash factors less than 1.35. Accordingly, the smash factor 2215 indicated in the outputs 2210 falls into the good category 2225, as shown. In some embodiments, these categories are determined using an average of that data from multiple swings. In some embodiments, these categories are determined using a statistical variation (e.g., subtracted value of the minimum value from the maximum value).

In some embodiments, different neural networks are used to process inputs from golfers of different golfer categories, with each of the different neural networks being trained to produce different types of outputs that are specific to the golfer category associated with that neural network. In some embodiments, the golfer category is determined, or further determined, according to a particular input entered by a golfer that indicates their experience and skill level. Advanced golfers may input their handicap to indicate their skill level to the swing analyzer, in some embodiments, whereas someone that is new to golf can indicate their experience and skill level as “beginner”. In some such embodiments, the neural network can combine the expressed experience and skill level with generated outputs to identify a proper category to assign to the golfer. In other embodiments, a golfer can be prompted to indicate an experience and skill level that is used to otherwise tailor the golfer's user-experience with the swing analyzer application. For instance, rather than determining a lexicon to use when providing outputs based on a skill level indicated by metrics included in the generated outputs associated with a golfer's provided inputs, the golfer's self-attested skill level can be used to determine a lexicon to use (e.g., a golfer can have a lot of experience and golf-related knowledge while still having an average or below-average skill level).

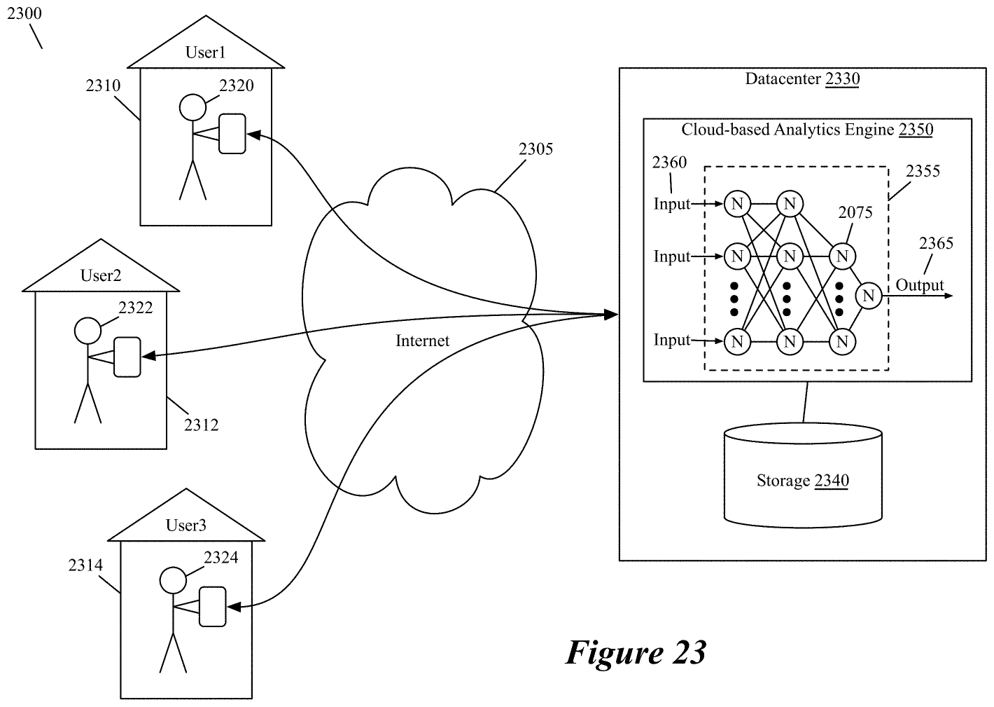

In addition to sound as input, some embodiments also use video as input for the swing analyzer. FIG. 23 conceptually illustrates a diagram of a system of some embodiments for analyzing and processing inputs associated with a set of golf swings and any corresponding impacts during the set of golf swings at a centralized location that includes a cloud-based analytics engine. As shown, the diagram 2300 includes a set of locations 2310, 2312, and 2314 at which three users 2320, 2322, and 2324 of the swing analyzer application are located, respectively. Each of the users 2320-2324 at the locations 2310-2314 is connected to the datacenter 2330 via the internet 2305. While illustrated as houses, the locations 2310-2314 can be any locations at which the users 2320-2324 use the swing analyzer application and have an available connection to the datacenter 2330, such as via a connection through the internet 2305 (or any other wide area network (WAN) that can connect user devices at various locations to the centralized datacenter 2330) as shown.

The datacenter 2330 is a public or private datacenter (e.g., public or private cloud datacenter), according to some embodiments. The datacenter 2330 includes a cloud-based analytics engine 2350 and a storage 2340, as illustrated. The storage 2340, in some embodiments, is used by the cloud-based analytics engine 2350 to store sets of inputs and corresponding sets of outputs received from and generated for users (e.g., users 2320-2324) of the swing analyzer application described herein. In some embodiments, the storage 2340 includes mappings between input and output pairs that can be used by the neural network 2355 to identify potential outputs based on similarities between received inputs and the mappings between the stored input and output pairs. The cloud-based analytics engine 2350 includes at least one neural network 2355 having processing units 2375 for processing input 2360 received from users 2320-2324 in order to generate output 2365, which is then provided back to the users 2320-2324 via the internet 2305, according to some embodiments.

In some embodiments, the input and output sets stored in the storage 2340 is used by the neural network 2355 of the cloud-based analytics engine 2350 to process input 2360 and generate output 2365. Also, in some embodiments, the storage 2340 is one of multiple storages located at the datacenter 2330 and used by the cloud-based analytics engine 2350. For instance, in some embodiments, the datacenter 2350 includes an input storage for storing inputs received from users 2320 that is queued-up for processing and retrieved by the cloud-based analytics engine 2350 when the neural network 2355 is ready to perform its processing and analysis of the inputs. Also, in some embodiments, the datacenter 2330 includes additional processors (e.g., processors similar to the processors described above for FIG. 4) for separating received inputs based on which processing unit 2375 of the neural network 2355 will be processing the inputs. For example, some embodiments separate inputs into subsets that include inputs associated with data before impact, inputs associated with data during impact, and inputs associated with data after impact.

When a user 2320-2324 provides inputs to the swing analyzer application that includes video input, in some embodiments, the video input is sent from the user's device (e.g., mobile telephone, tablet, computer, etc.) to the datacenter 2330 that hosts the cloud-based analytics engine 2350. During this time, the swing analyzer application on the user's device processes any other received inputs that can be processed on the user's device, such as sound data (e.g., audio files). After the video input is sent from the user's device, the video input is received at the datacenter 2330 for processing by the neural network 2355 of the cloud-based analytics engine 2350. The generated outputs and their corresponding inputs are then added to the storage 2340 (e.g., as input/output pairs), and the generated outputs are provided to the user via the user's device. In some embodiments, such as when a large amount of data is generated as outputs, and/or for reporting summary of results after a session, the outputs are made available to the user in another manner, such as being made available via an internet link for a particular website associated with the swing analyzer application, with the link being provided to the user via the swing analyzer application, or another means such as electronically, via SMS message, etc.

Unlike analysis and processing of sound data, which in some embodiments is performed in a manner of seconds and almost immediately available to a user after the swing (e.g., when the sound data is provided in a live feed directly through the swing analyzer application), the analysis and processing by the neural network 2355 of the cloud-based analytics engine 2350 in some embodiments takes more time for detailed analysis, perhaps even minutes to hours. In some embodiments, the feedback processed on the larger computing capability available in the cloud-based analytics engine runs in seconds so that the outputs that include feedback (e.g., analysis feedback and advice feedback) can be sent to the golfer's mobile device or devices, while the mobile device is still communicating its locally computed outputs to the golfer.

In some embodiments, the outputs generated by the cloud-based analytics engine based on video inputs are more detailed than the outputs generated based on sound inputs, and, in some embodiments, include more feedback for the user, such as analysis feedback regarding body positions, swing arc timing, etc., a summarized analysis indicating quality of the swing(s) (e.g., whether the swing was good), or an indication regarding whether a previously provided piece of advice feedback was executed. In some embodiments, the generated outputs include advice feedback on what to do or to think about to improve the quality of future golf swings.

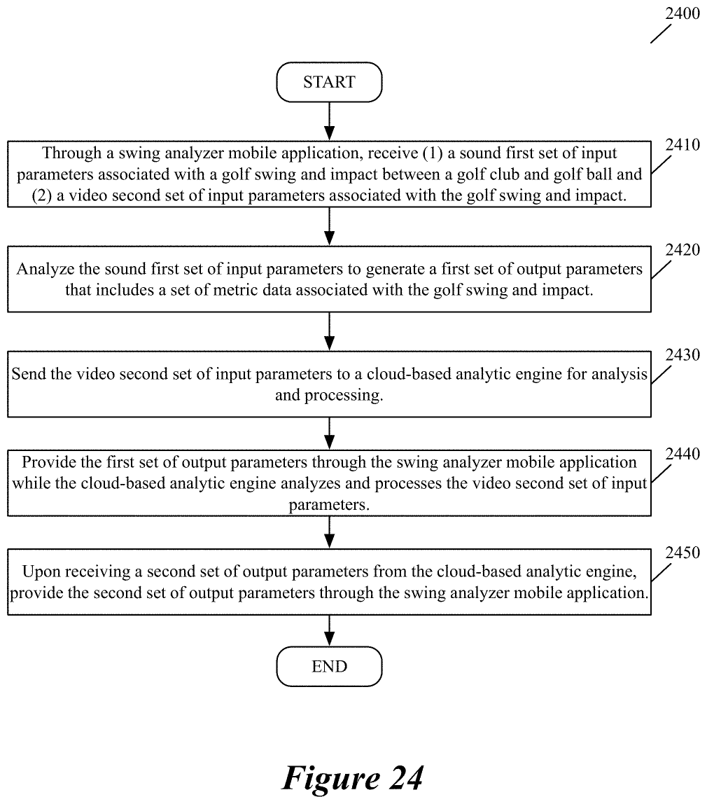

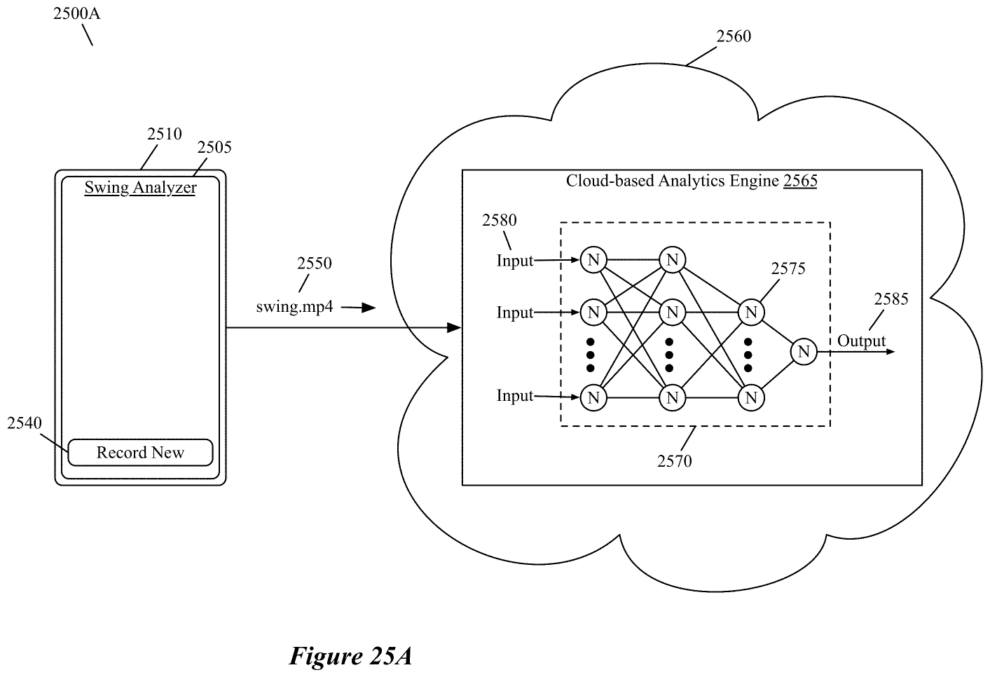

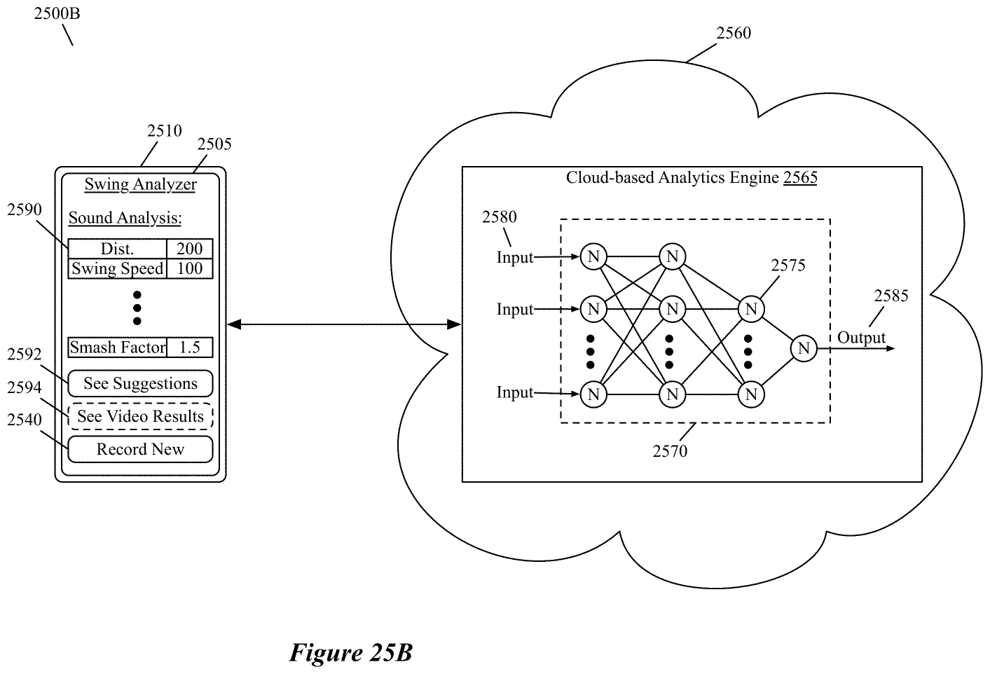

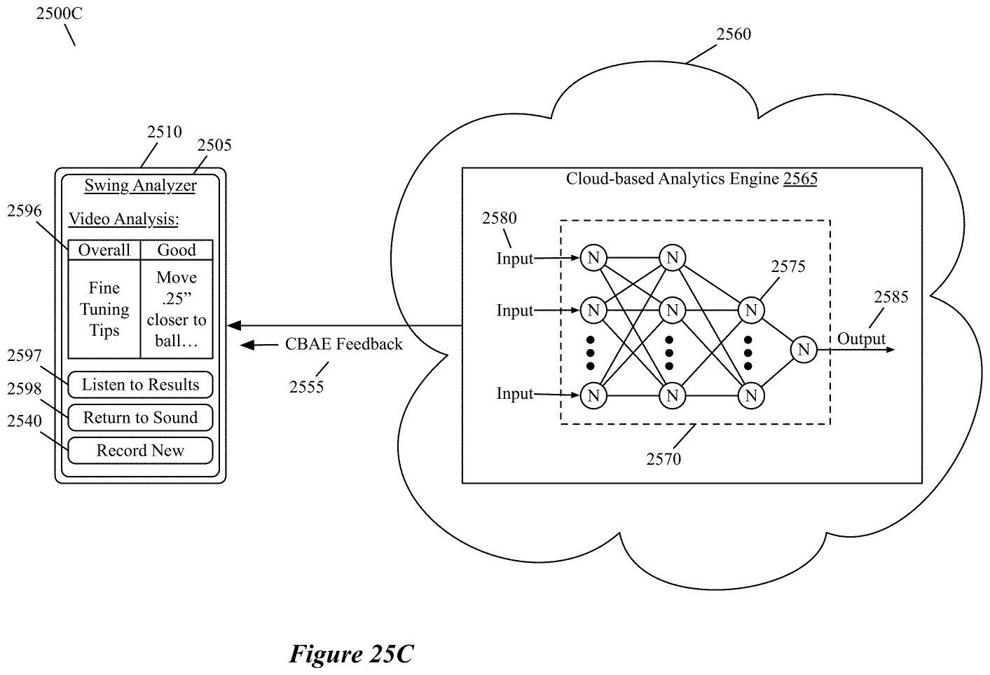

FIG. 24 conceptually illustrates a process of some embodiments for providing outputs based on sounds that are processed locally in a golf swing analyzer mobile application operating on a user device and video parameters that are processed externally at a cloud-based analytics engine. The local and cloud-based processing are performed, in some embodiments, by swing analyzers (e.g., swing analyzer mobile application and cloud-based analytics engine) that each include a trained neural network. The process 2400 will be described below with references to FIGS. 25A-25C, which conceptually illustrate diagrams of a workflow between the swing analyzer application and the cloud-based analytics engine.

The process 2400 starts when through the swing analyzer mobile application, the process receives (at 2410) a sound first set of inputs associated with a golf swing and impact between a golf club and golf ball and a video second set of inputs associated with the golf swing and impact. In some embodiments, the sound and video are recorded with the same user device, while in other embodiments, they are recorded with separate devices. For instance, in some embodiments, the video is recorded using a tablet device while the sound is recorded using a mobile telephone, or the video is recorded using a mobile telephone, while the sound is recorded using a smart watch. Other examples of recording devices of some embodiments can include portable computers (i.e., laptop computers), or video cameras.

In the diagram 2500a of FIG. 25A, the swing analyzer application 2505 is operating on a mobile device 2510. Mobile device 2510, in some embodiments, takes the video of the golfer with the front camera so that the screen can be facing the golfer in order to provide feedback through the screen. In some embodiments, the mobile device 2510 takes the video of the golfer with the back camera, for example, in a “coaching mode” where the device is being used by someone other than the golfer operating the mobile device. The mobile device can be oriented in portrait mode or in landscape mode, according to some embodiments. In some embodiments, the record button automatically changes to note that a video being taken in landscape mode is a front-on view, while the video being taken in portrait mode is a down-the-line view. The front-on view is a video taking the image of a right-handed golfer, swinging from the golfer's right to left. In this view, the swing is wider than tall, the landscape view captures the whole swing with less distance between the golfer and the mobile telephone. The down-the-line view is where the mobile telephone is positioned behind the golfer, looking down the target line to where the golfer is intending to hit the ball towards. In this view, the golf swing is taller than it is wide, allowing the mobile telephone to be closer to the golfer. In settings such as a golf practice range, space required between the mobile telephone and the golfer needs to be minimized.

The coaching mode may be invoked by an external setting, or by some user interface action such as flicking the screen to the right or by long-pressing the record button. Whether in coaching mode or not, landscape mode or down-the-line mode is noted, automatically detecting and recording the mode in the recorded video, such as by tags or by encoding into file names. In some embodiments, a smart watch is used in conjunction with a mobile telephone, connected to each other through a wireless connection. In some such embodiments, a record button appears on the watch, so that the golfer can start recording with the golfer already in position to swing the club, and stop the recording immediately upon deciding that the recording session is done.

Some of the feedback, including analysis or advice feedback is provided through the smart watch either visually or aurally in some embodiments. Sound and sensor data recorded by the smart watch are time stamped, in some embodiments, and sent to the mobile device, a mobile telephone or otherwise. In some embodiments, the mobile device gathers all data collected from all sources and aggregates the data to send to the cloud server 2560 for processing by cloud-based analytics engine 2565 or any other processing engine. The smart watch or the mobile device or any combination processes the sound first set of inputs simultaneously, in some embodiments, while the aggregated data is being sent to the cloud server 2560 in order to provide first set of outputs that include some first set of feedback to the user.

In some embodiments, the first set of feedback includes a virtual impact tape indicating the output of sound analysis indicating where the golf ball was struck on the club face. In some embodiments, immediate feedback is provided on each swing that includes the sound of impact. In some embodiments, a rudimentary video analysis that requires minimum computing resources detects a swing that impacts the ball. In some embodiments, video, sound, sensor data, and any other information is clipped for each impact detected to reduce the amount of data processed locally on the mobile device, and also transmitted to the cloud server.

A typical swing is 4-5 seconds long, while an entire recorded session that includes pre-shot routines, and post-shot routines, putting a new ball in position or on the tee, etc., typically takes 20-40 seconds per shot even without rehearsal swings. A significant compression of data is achieved by clipping the shots automatically. Multiple shots are captured in one session, in some embodiments, with one pressing of the record button. In some embodiments, the golfer is instructed by the mobile application to make a number (such as 3) of the same swings to try to hit the ball to the same location with the same ball flight. One recording session contains all impacts, but in some embodiments the collected data are all clipped via time stamps to aggregate all data of each of the shots separately.

In some embodiments, the analysis feedback or advice feedback is provided collectively after all shots of a recording session. The analysis feedback or advice feedback of some embodiments is provided for each shot immediately after each shot. In some embodiments, some analysis feedback is provided immediately after each shot, while some analysis feedback and some advice feedback is provided after all shots. Multiple sessions of recording sessions provide analysis feedback that relate to advice previously given in previous sessions, such as “that's it. You took it back with the club face covering the ball.”, or “take it back straight at first even more than that.”

In some embodiments, a smart watch captures sound and sensor data of a swing, sends the data to the mobile device which took a video of the swings at the same time, with the mobile device immediately processing the sound, sensor data, or both for immediate feedback, while additional data such as video taken by the mobile device along with all other data is transmitted to the cloud server for more intense computation including neural network inferencing to provide additional analysis feedback and advice feedback. The feedback may be provided to the golfer or the coach via mobile device, smart watch, visually or aurally through a listening device, or collected for later viewing by the golfer or by the coach or both. In some embodiments, multiple mobile devices may be used, potentially taking multiple camera angles of videos of the same swings, which may be aggregated by timestamp and sent to the server for processing, or stored for later processing.

The process 2400 analyzes (at 2420) the sound first set of inputs to generate a first set of outputs that includes a set of metric data associated with the golf swing and impact. The process analyzes the sound inputs locally on the user device to which the inputs are provided. In some embodiments, the sound is very rich due to the amount of data that can be analyzed with minimal computing power (i.e., when compared to video). As described in the embodiments above, a significant amount of data can be inferred and extrapolated from the sound alone, such as impact position yielding a virtual impact tape, ball speed, swing speed, spin, distance, etc. In addition to the metric data, the first set of outputs of some embodiments also includes additional inferences, such as analysis feedback of a quality level of the swing or swings associated with the sound inputs.

The process 2400 sends (at 2430) the video second set of inputs to a cloud-based analytic engine for analysis and processing. That is, unlike the sound parameters that are processed locally on the user device, the video parameters are instead sent to a centralized server (e.g., the cloud-based analytic engine) that has more computing power to perform a more in-depth analysis of the video parameters. The cloud-based analytic engine of some embodiments also has access to more data from all, or at least large portions of, users of the swing analyzer application, which the cloud-based analytic engine can use in its analysis and processing of the video parameters. In the diagram 2500a, for example, the “swing.mp4” file 2550 is illustrated as being sent to the cloud 2560 in which the cloud-based analytics engine 2565 is deployed. The cloud-based analytics engine 2565 includes a neural network 2570. The neural network 2570 includes multiple processing nodes 2575 for processing input 2580 (e.g., the “swing.mp4” file 2550) and generating output 2585.

The process 2400 provides (at 2440) the first set of outputs through the swing analyzer mobile application while the cloud-based analytic engine analyzes and processes the video second set of inputs. In the diagram 2500b of FIG. 25B, for instance, the swing analyzer application 2505 now displays a sound analysis that includes results 2590, a selectable UI option 2592 for viewing suggestions based on the sound analysis, and a currently non-selectable UI option 2594 to see video results that becomes selectable in some embodiments once the video results have been returned from the cloud-based analytics engine 2565. It should be noted that the UI items illustrated in the swing analyzer application 2505 in the diagrams 2500a, 2500b, and 2500c are merely exemplary and other embodiments of the invention may include other UI items in addition to, or instead of, those illustrated.

Upon receiving a second set of outputs from the cloud-based analytic engine, the process 2400 provides (at 2450) the second set of outputs through the swing analyzer mobile application. The diagram 2500c of FIG. 25C illustrates the swing analyzer application 2505 after the cloud-based analytics engine feedback 2555 has been returned from the cloud-based analytics engine 2565. The swing analyzer application 2505 now displays the video analysis results 2596, as well as a selectable UI option 2597 to listen to the results (i.e., through a voice assistant integrated with the swing analyzer application), and a selectable UI item 2598 to return to the sound analysis results. In some embodiments, the sound and video results are displayed consecutively on the same page rather than separately. Also, in some embodiments, while not shown, the sound results also include the selectable UI option 2597 to listen to the results. Following 2450, the process 2400 ends.

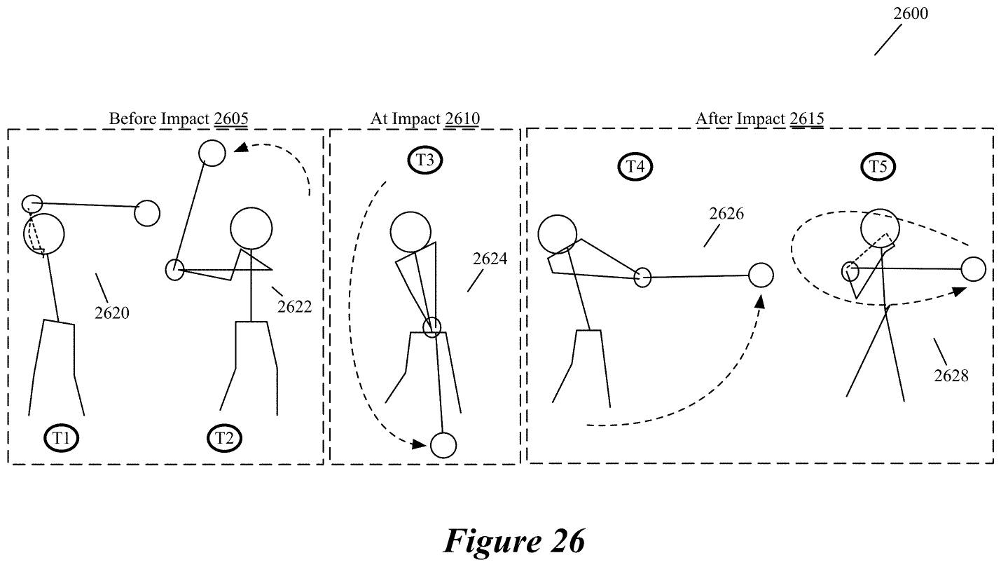

In some embodiment, the video input is divided into subsets based on timing, (e.g., before, during, and after impact), sound types (e.g., impact or non-impact), or other means (e.g., portions of the swing arc), as will be described below by reference to FIGS. 26-28. FIG. 26 illustrates a diagram of a golf swing 2600 that is separated into three categories—namely, before impact 2605, at impact 2610, and after impact 2615.

Before impact 2605, at time T1, the figure is in a first position 2620 with the golf club raised as they prepare to swing, and at time T2, the figure is in a second position 2622 as the swing commences. From time T2 to time T3, the figure moves from before impact 2605 to at impact 2610. As illustrated at time T3, the figure is now in a third position 2624 as the swing has reached the bottom of the swing arc and makes impact with a real or imagine target ball object (e.g., a golf ball). The figure is then in a fourth position 2626 at time T4 within the after impact 2615 category as the figure continues the follow-through with the golf club during the swing. The figure's final position 2628 at time T5 in the after impact 2615 category shows the figure has completed the swing.

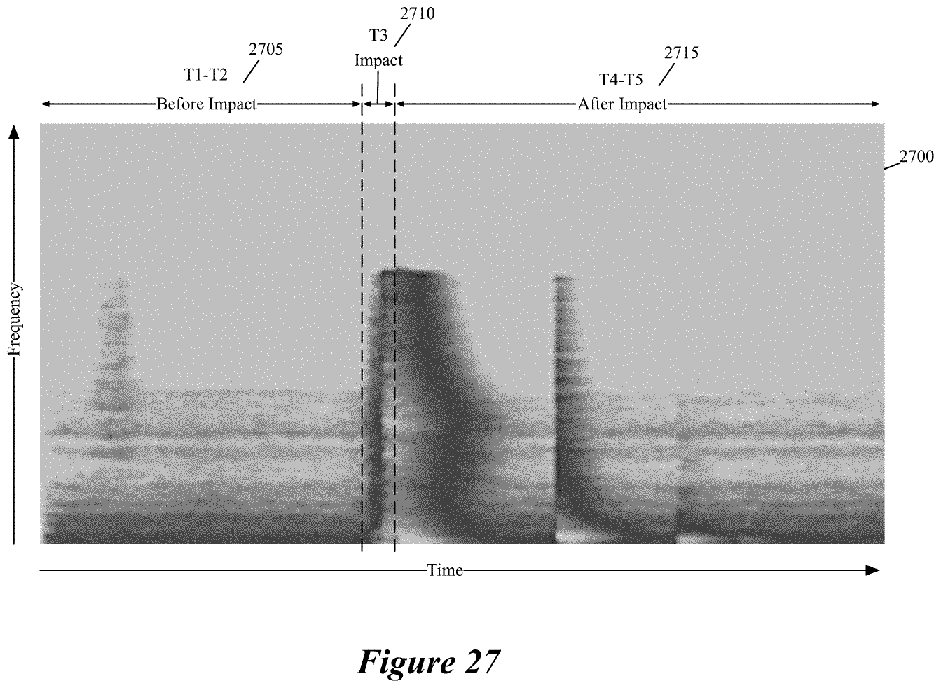

Presuming the swing in FIG. 26 included impact with a ball, FIG. 27 illustrates a spectrogram 2700 generated from sounds during the swing illustrated in the diagram 2600. The spectrogram 2700 is also divided into three categories—before impact 2705, at impact 2710, and after impact 2715, with each category including time stamps corresponding to the time stamps in the diagram 2600. As shown, little sound occurs in the before impact category 2705 as the figure in the diagram 2600 begins their swing. At impact 2710, a sound occurs that appears louder than any other sound on the spectrogram 2700 (i.e., based on the intensity and height at time T3). Immediately following the impact and within the after impact category 2715 during times T4-T5, the “swoosh” presumably occurs, and the swing is completed.

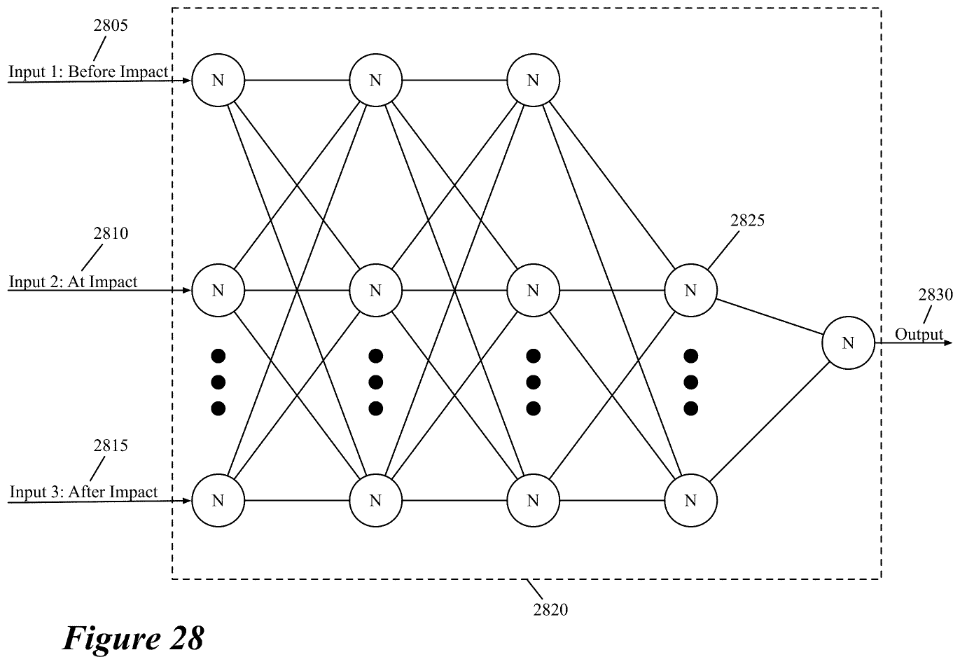

Based on the categories used to divide the diagram 2600 and spectrogram 2700, FIG. 28 conceptually illustrates a neural network 2820 that includes multiple processing nodes 2825 for processing inputs fed to the neural network 2820. In this example, three sets of inputs are fed to the neural network 2820, with each set corresponding to a category from the diagram 2600 and spectrogram 2700. As shown, input 1 2805 includes before impact parameters, input 2 2810 includes at impact parameters, and input 3 2815 includes after impact parameters. Each of the parameters 2805-2815 can include sound and/or video input, according to some embodiments. In some embodiments, the sound inputs are processed separately from video inputs, while in other embodiments, the sound and video inputs are processed separately by either the same neural network (i.e., consecutively) or by separate neural networks that are trained to infer and extrapolate data from either sound or video, respectively.

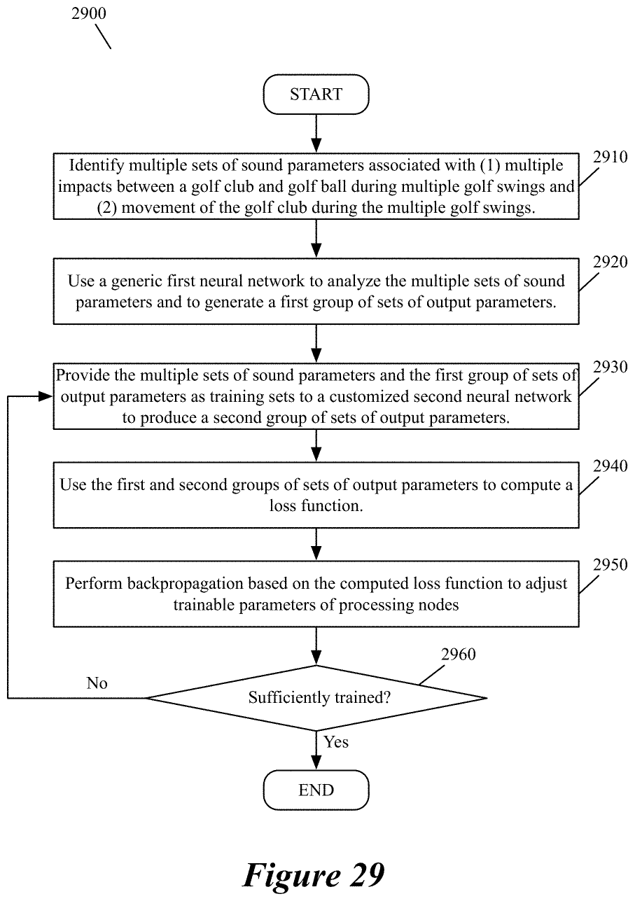

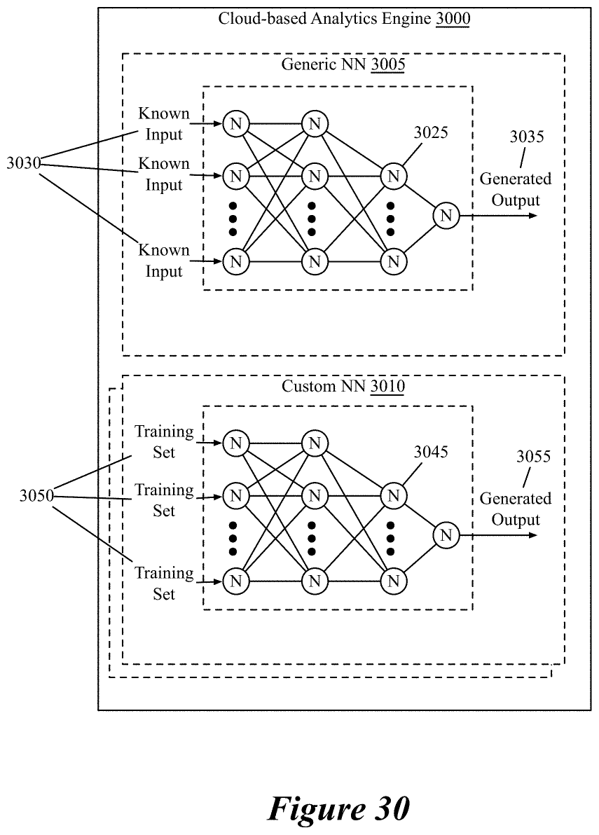

FIG. 29 conceptually illustrates a process of some embodiments for training a customized neural network for analyzing golf swings on a per-golfer basis. The process 2900 will be described below with references to FIG. 30, which conceptually illustrates an example of a cloud-based analytics engine that includes a generic neural network and multiple custom neural networks. The process 2900 starts when the process identifies (at 2910) multiple inputs (e.g., sound and/or video) associated with (1) multiple impacts between a golf club and golf ball during multiple golf swings and (2) movement of the golf club during the multiple golf swings. As described above, the non-impact sounds of some embodiments can include the “swoosh” sound made by the club as it is swung.

The process 2900 uses (at 2920) a generic first neural network to analyze the multiple inputs and to produce a first group of sets of generated outputs. For example, the cloud-based analytics engine 3000 includes a generic neural network 3005 that includes multiple processing nodes 3025. As shown, multiple known inputs 3030 are fed to the generic neural network 3005 for processing by the nodes 3025 to produce the generated outputs 3035. The generic neural network 3025, in some embodiments, processes inputs associated with multiple different swings from multiple different golfers.

The process 2900 provides (at 2930) the multiple inputs and the corresponding first group of sets of generated outputs as a group of training sets to a customized second neural network to produce a second group of sets of generated outputs. As illustrated by the cloud-based analytic engine 3000, the training sets 3050, which include pairs of the known inputs 3030 and the generated outputs 3035, are fed to the custom neural network 3010 for processing by the processing nodes 3045 to produce generated outputs 3055. While the generic neural network 3005 and custom neural network 3010 in this example are illustrated as appearing identical, the neural networks of other embodiments can include different numbers and configurations of processing nodes that differ between each other and from those illustrated.

The process 2900 uses (at 2940) the first and second groups of sets of outputs to compute a loss function that expresses a difference between the first and second groups of sets of generated outputs, with the first group of sets of generated outputs being used as known outputs corresponding to the known inputs in the training sets. For example, the custom neural network 3010 compares its generated outputs 3055 to the known outputs 3035 that are generated by the generic neural network 3005 (i.e., the known output) and included in the training sets to compute a loss function based on differences between the known and generated output sets. The custom neural network 3010 is only fed inputs that are associated with a particular golfer, according to some embodiments. In other embodiments, each custom neural network 3010 is trained for a particular category of golfer (e.g., professional, advanced, good, average, fair, poor) rather than on a per-golfer basis.

The process 2900 performs (at 2950) backpropagation based on the computed loss function to adjust the trainable parameters of the processing nodes of the neural network. In some embodiments, the neural network adjusts its parameters (i.e., weights) based on the computed loss function and a learning parameter. The parameters are adjusted, in some embodiments, in order to get the neural network to generate outputs that match the known outputs. That is, based on the loss function computed between the known output 3035 generated by the generic neural network 3005 and the generated output 3055 from the custom neural network 3010, the process increases or decreases weights associated with known inputs in order to decrease (and eventually eliminate or make negligible) the differences in subsequent iterations, according to some embodiments.

The process 2900 determines (at 2960) whether the neural network has been sufficiently trained. For example, the neural network is considered to be sufficiently trained, in some embodiments, when it is able to generate expected outputs and accurately infer, e.g., impact position on a clubhead based solely on the sound of the impact. When the process 2900 determines that the neural network has not been sufficiently trained, the process 2900 returns to use (at 2930) the neural network to process each training set to produce sets of generated outputs. In some embodiments, the process 2900 iterates through each of the training sets multiple times to train the neural network, according to some embodiments. Otherwise, when the process 2900 determines that the neural network has been sufficiently trained, the process 2900 ends. Once the custom neural network 3010 is trained, it can be implemented for the golfer or group of golfers (e.g., category of golfers) for which it has been trained.

As also mentioned above, the swing analyzer application of some embodiments operates on a user device such as a smart watch (e.g., an Apple Watch) that has both a microphone and a speaker. In some embodiments, when operating on a smart watch, the swing analyzer application also provides users with assistance in finding their golf balls after an errant shot. As the swing analyzer application can identify approximately how far and in which direction a golf ball travels, as well as the amount of side spin the had from the sound of the impact, the swing analyzer application via the smart watch can provide feedback to the user on where to find the ball, such as by providing audio feedback through the speaker of the smart watch (e.g., “the ball is located ahead and to the left”). In some such embodiments, the swing analyzer application operating on the smart watch works in conjunction with the swing analyzer application operating on another device compatible with the application, such as the user's mobile telephone or tablet.

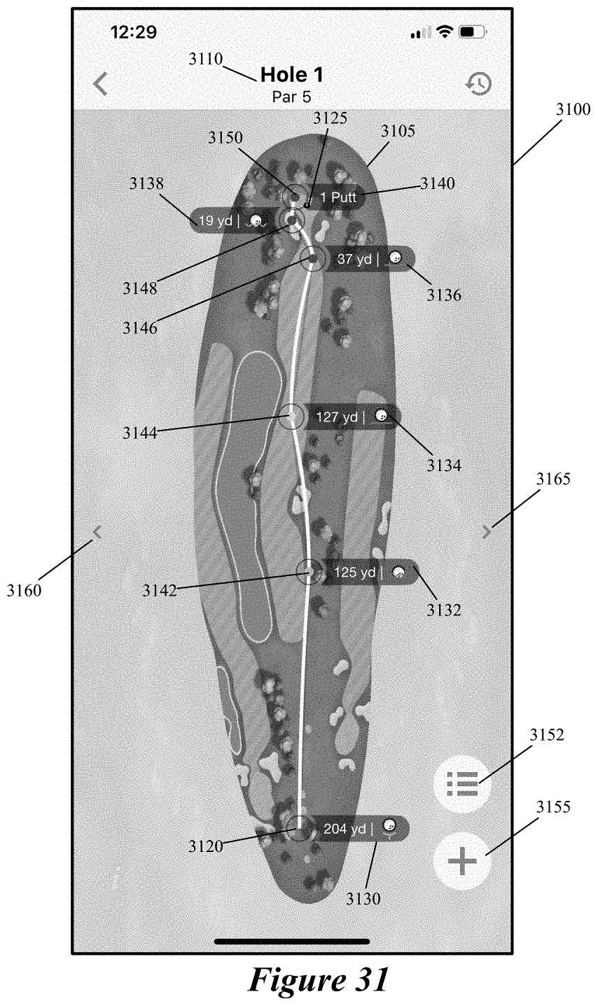

FIG. 31 illustrates a display provided by the swing analyzer application of some embodiments. As shown, the display 3100 shows a map 3105 of a portion of a golf course identified as “Hole 1” 3110 that extends from the teeing ground 3120 (i.e., the area where play begins for a hole of golf) to the cup 3125 (i.e., the hole and ultimate target for the golf ball). The display 3100 also includes a selectable UI item 3152 to toggle to a menu for the swing analyzer application (e.g., to view other aspects of the application, such as output metrics from a recent shot), a selectable UI item 3155 to add an additional map for an additional hole (i.e., the next hole), and selectable arrows 3160 and 3165 to toggle between existing hole maps. In some embodiments, other selectable UI items are included in the display 3100 in addition to, or as alternatives to the items illustrated. Also, in other embodiments, the selectable UI items 3152-3165 perform functions other than those described above in addition to, or as alternatives to the functions described.

In this example, all of the shots for this course have been take and are identified on the map 3105. The first shot resulted in the golf ball traveling 204 yards from the teeing ground 3120 to the location 3142 as indicated by the tag 3130 at the teeing ground 3120. The second shot resulted in the ball traveling 125 yards from location 3142 to location 3144 as indicated by the tag 3132. The third shot resulted in the ball traveling 127 yards from location 3144 to 3146 as indicated by the tag 3134. The fourth shot resulted in the ball traveling 37 yards from location 3146 to location 3148 as indicated by the tag 3136, and the fifth shot resulted in the ball traveling 19 yards from location 3148 to location 3150 as indicated by the tag 3138. A final putt, as indicated by the tag 3140, results in the ball traveling from location 3150 to the hole 3125.

In some embodiments, as the user (i.e., golfer) takes each shot, the map 3105 is updated with the location of the ball. The locations displayed on the map 3105, in some embodiments, are updated more than once, such as in instances where the swing analyzer application's estimate on the ball's location is inaccurate, or otherwise requires readjustment (e.g., when the ball lands in a body of water or other location from which additional shots cannot reasonably be taken). In some embodiments, the estimated ball location is provided to the user as a range (e.g., within 5 yards of a particular point indicated on the map 3105) and subsequently updated with the ball's exact location once it is found. The location estimates, in some embodiments, are provided as audio feedback from the user's smart watch and guides the user toward the ball as the user is traveling (e.g., by golf cart or by foot), and the display 3100 is provided on a device other than the smart watch (e.g., a mobile telephone) as a supplement to the audio feedback.

In addition to assisting the user with finding golf balls after errant shots (or any other shots), the swing analyzer application operating on a smart watch, in some embodiments, is also used to collect data about the user's next shot (i.e., next swing and impact with a ball) and the distance and direction to gather more training data to refine the neural network that processes data provided to the swing analyzer application as inputs off the impact sound of the previous shot. In some embodiments, the swing analyzer application operating on a smart watch analyzes both sound and impact shock, with the impact shock providing an indicator to the swing analyzer application that the shot was taken by the wearer of the smart watch on which the swing analyzer application is operating (i.e., as opposed to a shot taken by someone other than the wearer of the smart watch). Putts (i.e., shots taken with a putter), however, are not recognized by the swing analyzer application in some embodiments because not enough impact shock is generated for the putt to register with the swing analyzer application on the smart watch. In some embodiments, an option to record a putt is provided by the swing analyzer application on the smart watch prior to the putt to make up for the lack of impact shock resulting from the putt. In some such embodiments, after the user has selected to record a putt, the smart watch's microphone listens for, and records, sounds of the putt.

In some embodiments, the swing analyzer application operating on a smart watch can be used to collect data and provide feedback for multiple players in a group (e.g., a foursome) using both sound and shock data. For instance, for any sounds that are not indicated as putts, and also are not accompanied by impact shock, can be identified by the swing analyzer application operating on the smart watch as shots taken by players in the group other than the smart watch-wearer, and provide feedback accordingly. In other embodiments, when the swing analyzer application is set to record for multiple players, the swing analyzer application does not take any impact shocks into account and instead only intakes sounds. In order for the microphone of the smart watch (or other device) to pick up the sounds of the shots, the swing analyzer application of some embodiments requires the wearer of the smart watch on which the application is operating to stand within a particular distance of the current player (e.g., within 3 yards).

In some embodiments, before the game has commenced, the user having the swing analyzer application on their smart watch and other device(s) can input each player in the group in a particular order, and the swing analyzer application can subsequently record impact sounds for each shot taken at a hole and correlate the sound to a particular player based on the particular order (i.e., the first shot is correlated to the first play listed, the second shot is correlated to the second player listed, and so on), until each player has an associated shot, at which point the swing analyzer application returns to the top of the order for the next round of shots. In other embodiments, the user selects a particular player for which the next shot is to be correlated (e.g., selects player 1 before player 1 takes a shot, selects player 2 before player 2 takes a shot, and so on).

In some embodiments, other uses for the swing analyzer application operating on a smart watch are implemented. For instance, in some embodiments, the swing analyzer application operates on multiple devices that are used in conjunction with each other to record the sounds of swings and shots from multiple positions and provide an even more rich set of sounds for analysis and processing, which, in some embodiments, leads to more detailed feedback from the swing analyzer application. In some such embodiments, the swing analyzer application provides instructions on locations at which to place each device being used to record the sounds (e.g., “place the smart watch on your wrist and place the mobile telephone one yard behind you”). These locations, in some embodiments, are determined by the swing analyzer application based on a variety of factors, including the number of devices being used to record the sounds.

The inputs and outputs described in the examples above are examples of some of the possible inputs and outputs that may be used to train the neural network, use the swing analyzer that includes the neural network, and that may be generated by the neural network. In other embodiments, variations on multiple swings, shadow swings, pre-shot routines, instruction reinforcement, and further grip analysis may be included for inputs and outputs. In some embodiments, the outputs can include specifics for adjusting different body parts (e.g., elbows, knees, shoulders, etc.). Also, in some embodiments, the neural network can be one neural network that provides a variety of different outputs, while in other embodiments, the neural network can be multiple neural networks that each provide different types of outputs (e.g., one neural network that provides statistics, one neural network that provides feedback, etc.). As such, one of ordinary skill in the art will understand that other embodiments may include different (e.g., additional, fewer, other, etc.) inputs and outputs than those shown and described above.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

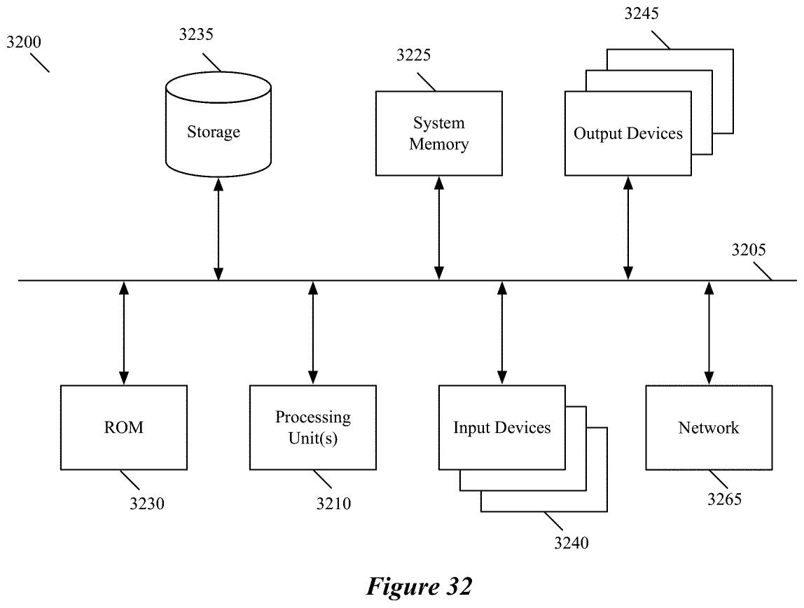

FIG. 32 conceptually illustrates a computer system 3200 with which some embodiments of the invention are implemented. The computer system 3200 can be used to implement any of the above-described hosts, controllers, gateway, and edge forwarding elements. As such, it can be used to execute any of the above-described processes. This computer system 3200 includes various types of non-transitory machine-readable media and interfaces for various other types of machine-readable media. Computer system 3200 includes a bus 3205, processing unit(s) 3210, a system memory 3225, a read-only memory 3230, a permanent storage device 3235, input devices 3240, and output devices 3245.

The bus 3205 collectively represents all system, peripheral, and chipset buses that communicatively connect the numerous internal devices of the computer system 3200. For instance, the bus 3205 communicatively connects the processing unit(s) 3210 with the read-only memory 3230, the system memory 3225, and the permanent storage device 3235.

From these various memory units, the processing unit(s) 3210 retrieve instructions to execute and data to process in order to execute the processes of the invention. The processing unit(s) 3210 may be a single processor or a multi-core processor in different embodiments. The read-only-memory (ROM) 3230 stores static data and instructions that are needed by the processing unit(s) 3210 and other modules of the computer system 3200. The permanent storage device 3235, on the other hand, is a read-and-write memory device. This device 3235 is a non-volatile memory unit that stores instructions and data even when the computer system 3200 is off. Some embodiments of the invention use a mass-storage device (such as a magnetic or optical disk and its corresponding disk drive) as the permanent storage device 3235.

Other embodiments use a removable storage device (such as a floppy disk, flash drive, etc.) as the permanent storage device. Like the permanent storage device 3235, the system memory 3225 is a read-and-write memory device. However, unlike storage device 3235, the system memory 3225 is a volatile read-and-write memory, such as random-access memory. The system memory 3225 stores some of the instructions and data that the processor needs at runtime. In some embodiments, the invention's processes are stored in the system memory 3225, the permanent storage device 3235, and/or the read-only memory 3230. From these various memory units, the processing unit(s) 3210 retrieve instructions to execute and data to process in order to execute the processes of some embodiments.

The bus 3205 also connects to the input and output devices 3240 and 3245. The input devices 3240 enable the user to communicate information and select commands to the computer system 3200. The input devices 3240 include alphanumeric keyboards and pointing devices (also called “cursor control devices”). The output devices 3245 display images generated by the computer system 3200. The output devices 3245 include printers and display devices, such as cathode ray tubes (CRT) or liquid crystal displays (LCD). Some embodiments include devices such as touchscreens that function as both input and output devices 3240 and 3245.

Finally, as shown in FIG. 32, bus 3205 also couples computer system 3200 to a network 3265 through a network adapter (not shown). In this manner, the computer 3200 can be a part of a network of computers (such as a local area network (“LAN”), a wide area network (“WAN”), or an Intranet), or a network of networks (such as the Internet). Any or all components of computer system 3200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of analyzing sounds produced during a golf swing and an impact between a clubhead of a golf club used for the golf swing and a target ball object, the golf swing performed by a particular golfer, the method comprising:
identifying (i) a first set of one or more impact sound parameters associated with the impact between the clubhead of the golf club used for the golf swing and the target ball object, and (ii) a second set of non-impact sound parameters associated with movement of the club through space during the golf swing;
analyzing the first set of impact sound parameters and the second set of non-impact sound parameters to extract a set of feedback parameters comprising at least (i) a set of metrics associated with the golf swing and the impact, and (ii) at least one suggested corrective action for improving the golf swing; and
providing the extracted set of feedback parameters to the particular golfer.

2. The method of claim 1, wherein analyzing the first set of impact sound parameters and the second set of non-impact sound parameters to extract the set of feedback parameters comprises analyzing the set of input data by a trained neural network to extract the set of feedback parameters.

3. The method of claim 1, wherein the set of metrics comprises (i) swing speed, (ii) swing path, (iii) ball speed, (iv) launch angle, (v) ball spin direction, and (vi) ball spin rate.

4. The method of claim 1, wherein providing the extracted set of feedback parameters to the particular golfer comprises providing the extracted feedback via a swing analyzer application operating on a user device of the particular golfer.

5. The method of claim 4, wherein prior to identifying the first set of impact sound parameters and second set of non-impact sound parameters, the method comprises receiving, through the swing analyzer application on the user device, a set of sound input collected during the golf swing.

6. The method of claim 4, wherein the swing analyzer application comprises a neural network, wherein before receiving the set of sound input, the method comprises training the neural network to infer the set of feedback parameters based on impact and non-impact sounds associated with a golf swing.

7. The method of claim 6, wherein:
the neural network comprises a plurality of processing nodes each having adjustable parameters;
each adjustable parameter comprises a weight associated with a connection between a pair of inputs;
adjusting one or more adjustable parameters of the neural network comprises increasing a weight associated with a connection between (i) volume of one or more sounds in sets of impact and non-impact sounds associated with a plurality of golf swings and (ii) duration of the one or more sounds in sets of impact and non-impact sounds associated with the plurality of golf swings.

8. The method of claim 4, wherein the user device comprises one or more of a mobile telephone, a smart watch comprising a speaker and a microphone, a mobile computer, and a tablet device.

9. The method of claim 1, wherein the at least one suggested corrective action is determined based on the second set of non-impact sound parameters associated with movement of the club through space during the golf swing.

10. The method of claim 9, wherein a second suggested corrective action is included in the set of feedback parameters, the second suggested correction action determined based on the first set of impact sound parameters.

11. A method of analyzing golf swings and impacts between clubheads of golf clubs used for the golf swings and target ball objects, the method comprising:
receiving, through a user device, a set of input data associated with a set of golf swings and associated impacts between a clubhead of a golf club used for the set of golf swings and a target ball object;
processing the set of input data to generate a first set of output data comprising at least a set of analytic metrics associated with the set of golf swings and the associated impacts;
based on the first set of output data, generating a feedback second set of output data that identifies at least one corrective action for improving subsequent golf swings; and
providing the first set of output data and the feedback second set of output data through the user device for use by a user of the user device.

12. The method of claim 11, wherein processing the set of input data to generate the first set of output data comprises processing the set of input data by a trained neural network to generate the first set of output data.

13. The method of claim 12, wherein generating the feedback second set of output data based on the first set of output data comprises using the first set of output data to select one of a first category and a second category to assign to the set of golf swings, wherein:
the trained neural network is a first trained neural network;
the first category is associated with (i) a first threshold range of statistical variance between each golf swing in the set of golf swings and (i) a second trained neural network for generating the feedback second set of output data; and
the second category is associated with (i) a second threshold range of statistical variance between each golf swing in the set of golf swings and (i) a third trained neural network for generating the feedback second set of output data.

14. The method of claim 13, wherein the first threshold range is associated with a higher statistical variance between each golf swing in the set of golf swings than the second threshold range.

15. The method of claim 14, wherein a higher statistical variance between each golf swing in the set of golf swings is associated with a lower skill level than a lower statistical variance between each golf swing in the set of golf swings.

16. The method of claim 15, wherein the second trained neural network generates a first type of feedback for the feedback second set of output and the third trained neural network generates a second type of feedback for the feedback second set of output.

17. The method of claim 11, wherein:
the set of input data further comprises an indication of a skill level of the user; and
generating the feedback second set of output data based on the first set of output data further comprises generating the feedback second set of output data based on (i) the first set of output data and (ii) the indicated skill level of the user.

18. The method of claim 17, wherein the indicated skill level of the user is used to determine a lexicon to use for the feedback second set of output data.

19. The method of claim 11, wherein the set of input data comprises at least sound data collected by the user device and associated with the set of golf swings.

20. The method of claim 19, wherein the set of input data further comprises a set of one or more videos collected by the user device of each golf swing in the set of golf swings.

21. The method of claim 11, wherein the user device comprises one or more of a mobile telephone, a smart watch comprising a speaker and a microphone, a mobile computer, and a tablet device.

22-55. (canceled)
